(19) United States
(12) Patent Application Publication
(10) Pub. No.: US 2009/0226308 A1
(43) Pub. Date: Sep. 10, 2009

(54) COMBINED COLD AND POWER (CCP) SYSTEM AND METHOD FOR IMPROVED TURBINE PERFORMANCE

(75) Inventor: David Vandor, Tarrytown, NY (US)

Correspondence Address: MITCHELL P. BROOK;LUCE, FORWARD, HAMILTON & SCRIPPS LLP, 11988 EL CAMINO REAL, SUITE 200, SAN DIEGO, CA, 92130, US

(73) Assignee: EXPANSION ENERGY, LLC, New York, NY (US)

(21) Appl. No.: 12/043,059

(22) Filed: Mar. 5, 2008

(51) Int. Cl. F02C 7/141; F28F 1/10; F25B 15/00

(52) U.S. Cl. 415/178; 165/182; 62/476; 60/772

(57) ABSTRACT

Systems and methods for improving the efficiency of gas-fired power systems that include heat exchange between at least two fluid streams comprise a vertical cold flue assembly comprising a plate fin heat exchanger and having a top and a bottom such that at least one fluid sinks through the top of the cold flue assembly, through the plate fin heat exchanger and sinks through the bottom of the cold flue assembly. An absorption chiller may be in fluid connection with the cold flue assembly and may use at least some waste heat from an exhaust stream to provide energy to produce refrigeration. The absorption chiller directs refrigerant into the cold flue assembly, the refrigerant rises within the plate fin heat exchanger and cools the at least one fluid including air as the air sinks through the plate fin heat exchanger, and the cooled air sinks through the bottom of the cold flue assembly and into the air compressor of the power system.

### FIELD OF THE INVENTION

The present invention relates to turbine power systems.

### BACKGROUND

Turbine power output ratings are based on International Standards Organization (ISO) standards, which assume that the ambient inlet air temperature delivered to the turbine is 59° F. Yet, in large portions of the US, where power is produced for on-site distributive generation, the average annual ambient air temperature is significantly warmer than 59° F., especially in the summer months. At the 59° F. ISO standard for inlet air, a standard turbine may achieve its rated power output but will not achieve the highest possible level of fuel efficiency that can be achieved with colder inlet air. In much of the world, where mini-turbines are likely to be deployed for local power production and/or to power air conditioning or refrigeration systems, ambient temperatures are much warmer than 59° F. for the entire annual power production cycle, and are often accompanied by high levels of humidity. With global warming, rising ambient temperatures will continue to have a negative impact on the performance of gas-fired turbines. At warmer ambient temperatures, gas-fired turbines will produce as much as 50% less power than their ISO-rating. Hot weather also causes the efficiency of turbines to fall off significantly during warmer-than 59° F. operating days (although efficiency is not optimal in cold climates either). Thus, there is a need for increased efficiency and output for turbines operating in warm weather.

The first issue (lower output during warm days) may require that end users buy a larger turbine than needed in order to offset the shortfall during warm periods. For example, if a distributive generation facility needs 250 kW of power, it may need to settle for two smaller turbines, e.g., each with 150 kW of output, for a total capacity of 300 kW, so that on hot days, the full 250 kW of output can be achieved. That choice is more expensive and yields two less-efficient prime movers, than a single turbine that might have produce the required 250 kW.

The second issue (reduced efficiency) implies a higher operating cost per kilowatt-hour (kWh) of power output, and a proportionally higher emission output. For example, a 250 kW turbine that only produces 200 kW during warm periods, will not only fall short of the intended power output, but will achieve that lower output only by burning fuel at a higher rate (per kWh of output) than when the turbine operates at the ISO assumed 59° F. The increased fuel per kWh of output results in a proportional increase in emissions per kWh. Thus, the standard turbine's “internal” operating costs rise in warm climates, as do its “external” emission costs.

Those in the industry that are familiar with those two problems have sought solutions that include the delivery of cold inlet air to the turbine's compressor (front-end), using a variety of methods. Sending cold inlet air to the compressor is a technique that is independent of any other optimizations that might be sought for the efficiency of the compressor, expander, generator, or recuperator in the turbine. In other words, even the most sophisticated and well-designed turbine's performance will suffer from warm inlet air, and any turbine will benefit from cold inlet air that may be provided by the present invention, either as a retrofit or as part of the original equipment.

At larger scale Combined Cycle power plants, waste heat is generally found not at the steam bottoming cycle but at the front end where the gas turbine's waste heat is used to produce the steam. That front-end heat recovery is, in most cases, “incomplete” because more heat is sent up the flue, as turbine exhaust, than is required for the proper operation of the flue gas exhaust system. In large gas turbine-based Combined Cycle power plants a substantial portion of the gas turbine (GT) exhaust heat is captured in the steam bottoming cycle. The GT exhaust is typically vented to the atmosphere at approximately 250° F. Any “standard” attempt to capture a portion of this exhaust heat is not cost effective, as demonstrated by the fact that it is not done at commercial, base-load, Combined Cycle power plants. The recovery of that low-grade exhaust heat is likely considered as having a “diminishing return”. When the heat carried by the turbine exhaust is sent up the flue (and thrown away), or used in a low-efficiency Organic Rankine Cycle (ORC) power enhancement system, or a Combined Cycle attachment that uses water/steam in a secondary turbine, the alternatives tend to be expensive (relative to total extra power output) at prime mover scales of less than 10 MW.

Low-grade heat may not be worth capturing (by standard methods) because it would add a net power output gain of only 1.5% to 2.0% while increasing capital costs and GT exhaust pressure drop. It would also promote corrosion in the heat recovery heat exchanger and piping downstream of the traditional Heat Recovery Steam Generator, which would require expensive stainless steel alloys. Furthermore, a need to achieve close heat exchanger approach temperatures would add to capital cost. In short, most existing Combined Cycle power plants do not fully utilize the available waste heat because standard applications of that heat do not yield enough power gains to offset the costs of using that low-grade heat. Thus, there is a need for a system that can fully utilize waste heat.

There also is the need to reduce emissions in all power plants that use hydrocarbons as fuel. A seldom-mentioned aspect of greenhouse gas emissions is the emissions of “waste heat” within the “greenhouse” that humans have caused. Flue exhaust from a standard simple cycle turbine can be 500° F. and warmer. The impact of that on the surrounding local environment, and the global impact of many such waste heat sources, may contribute to global warming, compounding the “greenhouse effect” of CO2 emissions.

Another problem concerns the operating pressures of mini- and micro-turbines. The fuel gas pressure (say, natural gas from a pipeline) must match the pressure of the compressed air that the front end of the turbine sends to the combustion chamber. The compression of the air (which represents approximately 97% of the flow through the combustion chamber, and later through the hot gas expander) is work-intensive. However, that work input is necessary in order to achieve enough pressure so that the hot gas expander can do enough work to spin the generator. The higher the design pressure of the turbine the more work will be required from the compressor, but the greater the work recovered through expansion. The problem with this approach is that the higher the design pressure, the more the turbine's deployment potential is limited. For example, if a turbine is designed to operate at 150 psia, it needs to be located at a pipeline that delivers natural gas at 150 psia. If it is to be located at a lower-pressure pipeline, then some of the turbine's power output needs to be diverted (wasted) on a booster compressor that raises the low-pressure pipeline gas from, say, 60 psia to 150 psia.

There are several known inlet air-cooling systems, including evaporative cooling systems. However, they have severe limitations related to local climate conditions. High relative humidity (such as in Houston Tex., or Bangladesh) greatly reduces the effectiveness of evaporative cooling systems. In the US, the use of evaporative coolers is limited to the arid western states. Even in dry areas, evaporative cooling systems are limited to closely approaching the wet bulb temperature, which can still be significantly warmer than winter or ISO conditions. Thus, under ideal conditions, evaporative cooling systems offer limited benefits relative to cooling the inlet air, and they require significant amounts of make-up water. That “cost” is especially important in arid areas, where the goal of water conservation can conflict with the need to improve turbine power efficiency. Thus, there is a need for a system that can increase the benefits of cooling of inlet air by achieving substantial cooling in extreme climate conditions.

Some pre-cooling systems use mechanical refrigeration to chill the inlet air. Those systems can achieve colder inlet air than evaporative coolers but at the “cost” of a significant amount of power required to run the mechanical refrigerators. That power would come from the extra power output that results from the cooled inlet air. To some extent, mechanical refrigeration “chases its own tail”, and may only be economical in some special circumstances. A mechanical refrigerator (with ammonia, Freon, a hydrocarbon, or some other working fluid), when used to moderately cool a 250 kW turbine's inlet air, say, to 35° F., would consume approximately 25 kW of power. That expenditure would yield 75 kW of “extra” gross output from the prime mover, for a total net gain of 50 kW. Thus, a turbine rated at 250 kW, which without the refrigerator would yield only 200 kW on a hot day, would be able to mitigate that loss of output with a mechanical refrigeration unit, but at a significant “cost” in overall fuel efficiency. That fuel cost is due to the fact that the mechanical refrigerator does not operate on waste heat, but is driven by the fuel-using prime mover, which would use some 25% more fuel to produce the 50 kW net power output gain that would restore the 200 kW hot-day output to 250 kW. Thus, there is a need for a GT inlet air pre-cooling system that can achieve cold inlet air without increased fuel use and without reduced power output efficiency.

Regarding capital costs, the mechanical refrigeration unit would cost approximately the same as an Ammonia Absorption Chiller (AAC). Aiming for colder inlet air would be very costly with mechanical refrigeration, with no overall efficiency benefits. Absorption chillers, such as those that use Lithium Bromide or Ammonia as working fluids, use the waste heat from the turbine to produce refrigeration that will cool the inlet air. Both can operate efficiently without any added heat source. In that sense, the benefits they achieve come at virtually no “energy cost”.

Evaporative chillers and Lithium Bromide absorption chillers (LBAC) have limits on how cold they can chill the air. (Evaporative chillers have “costs” related to water use, and mechanical chillers have costs related to powering the refrigerator.) Most chillers aim to provide air that is not colder than approximately 35° F. The other known systems can produce colder air, but are not used to achieve that goal because of heat exchanger freezing issues and because of the power demand required by the mechanical chiller and/or the fan that is needed to blow the air through the heat exchanger. (The drying of ambient air, in order to avoid freezing is a complex process that would not be viable except in large systems.)

Lithium Bromide chillers can produce moderate refrigeration, generally above freezing. However, the density of the moderately chilled inlet air to the turbine's compressor would not be especially high, and the resultant power output benefits (for simple cycle turbines at, say, 10 MW and less), will not be much better than those produced by evaporative or mechanical refrigerators. In that sense the options mentioned above are equally “limited” and have not been widely deployed.

Ammonia absorption chillers can produce colder inlet air, but there are no practical systems that can deeply chill the air and, at the same time, avoid a significant pressure drop through a heat exchanger, also avoid ice build up due to the moisture content of the air to be chilled, achieve a close approach temperature between the two streams that travel thought the heat exchanger, and do so within a reasonably sized heat exchanger. Thus, without solving those conflicting agenda items, ammonia chillers can only be harnessed for moderate refrigeration. On the other hand if an ammonia chiller is used to provide moderately cold inlet air, then that cooling capacity is not fully utilized.

There is a need to achieve deeply chilled turbine inlet air, beyond the limited capacity of evaporative coolers or Lithium Bromide absorption chillers, and without the power “cost” of mechanical refrigeration systems. The deeply chilled air needs to be delivered to the turbine's compressor, without a significant pressure drop (from the 14.7 psia ambient conditions at sea level, to not much less than that at the compressor flange), and without the need for a complex air-drying system that helps avoid icing in the heat exchanger as the humid air cools from, say, 95° F. to, say, −10° F. A “standard” version of a shorter less expensive heat exchanger, which would yield a smaller pressure-drop, will not be able to achieve the 5-degree approach.

Condensation removal can contribute to increasing efficiency, but because most such systems are horizontal, the effects of gravity on the droplets of water that form are not as efficiently transferred to the system as in a vertical configuration. (Water chillers in liquid O2 plants are horizontal, but use a downward sloping pipe to force the water into a vertical separator.) The drip collection pans may be near horizontal, but the surfaces of “horizontal” heat exchangers want to be at least at some angle to allow the water to drip down.

In typical gas-fired turbines, all the moving parts are in a left-to-right, horizontal configuration, with the common shaft parallel to the ground and the rotating parts spinning perpendicular to the earth. This standard configuration does not take advantage of the effect of gravity on the chilled inlet air, where inlet air cooling systems are employed.

In the absence of the present invention, the industry has aimed to recover the waste heat of simple cycle mini- and micro-turbines in Combined Heat and Power (CHP) systems, where the waste heat is used to heat water (for hot water demand in laundries, hospitals and other facilities with large hot water demand) or to produce space heating. Those heat recovery systems have significant limitations. Large-scale hot water demand is not a common need in most standard buildings where distributive generation by micro- or mini-turbines may be deployed. In hot climates, the provision of hot water and space heating, are not especially useful ways of recovering waste turbine heat.

Therefore, there exists a need for a system that can increase the efficiency and output of gas-fired turbines in warm weather. There is also a need to reduce the emissions of power plants that use hydrocarbons as fuel. Specifically, there is a need for an inlet air cooling system that can achieve cold inlet air without a significant increase in fuel demand. There exists a need to increase the efficiency of gas-fired turbine power systems beyond what is possible in the standard horizontal configuration and beyond what is possible in combined heat and power systems.

### SUMMARY

The present invention, in its many embodiments, alleviates to a great extent the disadvantages of known gas-fired turbine power systems by providing a system to increase the efficiency (and reduce the emissions) of gas-fired prime movers, not by recovering waste heat for marginal ancillary CHP applications in an adjacent, non-power-generating service, but by recovering waste heat for combined cold and power (CCP), called Vandor's Combined Cold and Power Cycle (VCCP), where the prime mover is the recipient and immediate beneficiary of the recovered cold. The VCCP Cycle selects a different use for heat recovery from the expansion exhaust, using it for refrigeration via a chiller to cool inlet air. However, if enough other sources of waste heat are available, or if pre-cooling by other than an absorption chiller is available, the VCCP Cycle can be integrated with an Organic Rankin Cycle system, where the VCCP Cycle provides cold inlet air to the prime mover, and where the Organic Rankin Cycle system provides additional power by way of recovered heat. That shift in emphasis, from CHP to CCP allows for a broader range of heat recovery and cold recovery integrations, but always directing the efficiency and emission benefits to the prime mover, rather than to adjacent functions that might intermittently use the waste heat. Thus a preferred embodiment of the present invention uses all the practically available waste heat (which is relatively low-grade, but large in volume) to produce refrigeration, which will pre-cool the inlet air to the prime mover's front-end compressor, and secondly, to warm the fuel stream. This advances the cost-effective production of cold (dense) inlet air to gas-fired turbines by aiming for the coldest possible inlet air temperatures, produced from the waste exhaust heat of the turbine, without any additional fuel input.

Some embodiments of the invention, by delivering cold inlet air to the turbine compressor, will address many of the shortcomings of existing micro- and mini-turbine technology, including reduced power output and reduced fuel efficiency at warm ambient temperatures. In the most basic embodiment of the invention, the air entering the insulated “cold flue” (described in detail herein) would be ambient air, drawn from the surrounding environment. On the hottest days, that option may stress the ability of the absorption chiller to provide deeply chilled inlet air to the compressor. Thus, for deployments in hot climates, where the ambient conditions are likely to be consistently hot (sometimes approaching triple digits) and humid, several pre-cooling methods can be adopted. It should be noted that the pre-cooling methods described herein also increase efficiency in cold climates.

Embodiments of the present invention will substantially improve the efficiency of gas-fired turbines, requiring lower fuel use per kilowatt-hour (kWh) of power output than other approaches, particularly at the under 10 MW scale, thus reducing the emissions per kWh on a proportional basis. Embodiments of the present invention reduce the temperature of the waste heat stream by converting that heat to work, and seek to receive adjacent waste heat (say, from the flue of a space heating unit in a large building) for use by an absorption chiller, to further enhance the energy output of the on-site power plant. In short, embodiments of the present invention “absorb” waste heat (its own and that of a neighboring source) converting it to work and keeping it from warming the “greenhouse”. Instead of mitigating the loss of hot exhaust heat thorough marginal auxiliary uses for the waste heat, the present invention seeks to maximize the prime mover's power output by re-use of that waste heat to chill the inlet air to the prime mover. In addition, where adjacent sources of waste heat are available, that heat can further enhance the cooling efforts of the invention's absorption chiller, further improving the power plant's efficiency by recycling waste heat that would otherwise be sent up a flue.

Embodiments of the present invention allow gas-fired micro- and mini-turbines to optimally operate at 60 psia, rather than the higher pressures commonly required by commercially available micro- and mini-turbines. Pipelines that deliver natural gas at 60 psia and above are more common than those that deliver natural gas at 89 psia, or 100 psia and above, allowing a wider realm of deployment of the invention, without the need for booster compressors. Embodiments also allow the gas turbine to produce its full rated output on hot summer days with no additional fuel consumption. It would also increase the efficiency of the combined cycle by as much as 7% to 8% on the hottest days and by a minimum of 3% on average on cool days, with proportional decreases in emissions. The techniques described herein may be combined with other mechanical improvements to simple cycle gas turbines and to the individual components (compressor, expander, generator, recuporator, combustion chamber, etc.) that make up the power plant. In others words, the efficiencies of the VCCP Cycle can be further enhanced by improving the core turbine components.

A preferred embodiment of the present invention comprises a cold flue assembly having a top and a bottom, including an insulated aluminum plate fin heat exchanger configured to operate in a vertical manner (with the plates in an optimum, such as concentric circle, arrangement) so that the entire assembly resembles (in a horizontal cross sectional or plan view) a round “flue”. Instead of a normal flue that efficiently allows hot gases to rise to the top of the flue by “stack effect”, the “cold flue” design allows the chilled air to sinks through the top of the cold flue assembly, where it enters the flue at atmospheric pressure (14.7 psia) and warm temperatures (say, as warm as 95° F.), laden with as much as 55% relative humidity, and continues falling by gravity as it is chilled in the cold flue, sinking through the plate fin heat exchanger, increasing its density as it falls deeper into the flue, and reaching the bottom, sinking through the bottom and passing into an air compressor through the inlet to the compressor flange at sub-zero (F), with very little pressure drop, without the need for electric powered blowers and fans to move it along. This establishes an operating pressure for the prime mover that is as low as practical so as not to require booster compressors for the fuel gas and to allow the improved turbine configuration to be deployed at lower-pressure pipelines, which are more common than high-pressure lines. As the chilled air falls down the cold flue, its moisture content condenses and is “caught” on condensation plates at an intermediate point between the top and bottom of the cold flue. The condensation plates allow the condensed water to exit the cold flue and for its refrigeration content to be recovered as described below. An atomized stream of antifreeze, such as ethanol or ammonia, may be sprayed into the falling, cooling air stream to prevent the remaining water from freezing. which, if left untreated, would cause the cold flue to ice up as the air falls further down. The vertical configuration of the cold flue and the concentric circular arrangement of the plates that separate the chambers within the heat exchanger allow various gases (such as pipeline natural gas) to be chilled by counter-flowing refrigerant, whereby the increasing density of the cooling and falling gas propels it “down” the cold flue toward the compressor's inlet nozzle, reducing the pressure drop of the gas during the cooling process and allowing it to enter the compressor. Thus, the cold flue assembly improves efficiency by facilitating heat exchange between at least two fluid streams, wherein at least one of the fluids is preferably air.

The insulated (vertical) configuration of the plate fin heat exchanger (the primary component of the cold flue assembly) will achieve the close temperature approach that plate fin heat exchangers are known for, in a relatively small height, with very little pressure drop. If the pressure drop is too significant, the benefit of the dense air will be partially lost, because the compressor would need to do more work to bring the low-pressure inlet air up to the design pressure (say, 60 psia) of the turbine.

The system also may include a turbine assembly comprising an air compressor, a generator and a hot gas expansion turbine, wherein the hot gas expansion turbine may be a mini-turbine or a micro-turbine. The turbine assembly may be characterized by a substantially vertical arrangement and a common substantially vertical shaft on which the turbine's air compressor, the hot gas expansion turbine and the generator are mounted, with the compressor located substantially directly below the cold flue assembly and in fluid connection with the cold flue assembly. Thus, the falling cold, dense air will not need to change direction from its vertical drop through the cold flue to a horizontal path as it enters the compressor, eliminating another point where pressure drop might occur. It should be noted that, in a preferred embodiment, the turbine assembly operates in a substantially vertical configuration such that the plane of rotation of the air compressor, the generator and the hot gas expansion turbine is substantially parallel to the ground. However, the system of the present invention can just as easily be utilized in conjunction with a turbine power system in the standard horizontal arrangement, as would be common when used as a retrofit.

The interior of the vertical cold flue may include “condensation plates” at an intermediate point, where the moisture content of the air is condensed, (say, at the point where the air is cooled to 35° F.), and where 90% of that moisture leaves the cold flue as 35° F. water. (That cold water will be recycled, first through cold recovery, and then in the make-up water stream of the absorption chiller's cooling tower.) In the vertical configuration of some embodiments of the present invention, there will be a natural “flow” downward of condensed water from the heat exchanger surfaces to the drip collection pans.

Embodiments of the present invention further comprise an absorption chiller in fluid connection with the cold flue assembly. The absorption chiller produces refrigeration and directs the refrigerant into the cold flue assembly. Specifically, the pumped to pressure refrigerant rises within the plate fin heat exchanger of the cold flue assembly and cools the air as the air sinks through the plate fin heat exchanger. The cooled air sinks through the bottom of the cold flue assembly and into the air compressor. Embodiments of the present invention further comprise a combustion chamber, a recuperator and an exhaust system, which are typical of simple cycle gas turbine power systems. The compressed air from the air compressor is directed to the recuperator, which is in fluid connection with the hot gas expansion turbine, the air compressor and the absorption chiller. The recuperator is a heat exchanger that has two streams through it: the compressed air from the front end compressor portion of the turbine assembly, and the hot exhaust gas being sent out of the hot gas expander portion of the turbine assembly. The recuperator then warms the compressed air by heat exchange with a hot exhaust stream from the hot gas expansion turbine, and the warmed compressed air is directed to the combustion chamber, which is in fluid connection with the recuperator and the hot gas expansion turbine. At least some waste heat from the exhaust gas that warmed the compressed air in the recuperator is directed from the recuperator to the absorption chiller, and the waste heat provides energy to the absorption chiller to produce refrigeration. The chilling duty may be performed by the absorption chiller technology, which will utilize all of the available waste heat from the turbine, after that waste heat has been partially used in the standard recuperator that warms the compressed inlet air, before its arrival in the combustion chamber. A significant portion of the heat carried by the turbine exhaust is available to the chiller, in lieu of sending it up the flue (and throwing it away), or in lieu of using it in a low-efficiency Organic Rankine Cycle (ORC) power enhancement system, or in lieu of using it in a Combined Cycle attachment that uses water/steam in a secondary turbine.

The refrigeration required to deeply chill the inlet air will be entirely derived from the waste exhaust gas from the turbine, where that waste heat will be converted to cooling by an Ammonia Absorption Chiller or a Lithium-Bromide Absorption Chiller. The inlet air to be chilled will initially be at or near ambient temperature and pressure, and will be heat exchanged with the cold refrigerant in a unique heat exchanger design.

Embodiments of the invention will allow the power plant to operate at relatively low-pressures. In particular, the air is delivered to the turbine's front end compressor with very little pressure drop. No ice will form in the heat exchanger, even in very humid climates, but without having to integrate complex, energy robbing air drying systems. The temperature approach between the refrigerant and the cold outflow air that leaves the heat exchanger will be very close (approximately 5° F.). The close approach temperatures (say, 5° F. between the −15° F. refrigerant and the −10° F. exiting air) can be more easily achieved in a large, more expensive heat exchanger, but one that would (because of its length) cause more pressure-drop in the air. On the other hand, a “standard” version of a shorter less expensive heat exchanger, which would yield a smaller pressure-drop, will not be able to achieve the 5-degree approach.

That combination of deeply chilled air, produced in a non-icing, low-pressure-drop, close approach temperature heat exchanger (part of the cold flue assembly of the present invention) will substantially advance the technique for sending air to the front-end of gas-fired turbines, requiring less work by the compressor, and using up more of the waste heat from the back-end exhaust stream than without the invention, yielding an unusually high power output to fuel-use ratio. At the under 10 MW scale, that use of as much of the waste heat as is practical, to produce deeply cooled inlet air, is preferred to using waste heat in Combined Cycles (steam bottoming) or in Organic Rankine Cycles, because the deeply chilled inlet air will yield higher power output efficiencies in a simpler, less costly configuration. Higher efficiency (or lower amounts of fuel used per kWh of output) yield lower emissions per kWh. Another significant benefit of the invention is that a cooler outflow stream from the turbine's flue will have less of a negative impact relative to warming the surrounding context.

The CCP approach also allows for the integration of moderate source of cooling (such as geothermal sources), and the use of recovered cold from a variety of cryogenic vaporization processes, thus improving the turbine's performance. If these other sources of cooling are available, any leftover waste heat not used to produce refrigeration could be used to warm the fuel stream. The two uses of waste heat—cooling inlet air to the compressor and warming the fuel stream—should use up all the available waste heat and yield substantially increased efficiencies for the power plant. Thus, instead of finding marginal uses for waste heat produced by the turbine (as in CHP systems), the CCP model seeks productive uses for marginal sources of cold and for unused waste heat from adjoining equipment. CCP is a retrofit option not only at existing installations that never tried CHP attachments, but also for those that achieved only marginal benefits with CHP, such as in warm climates where hot water demand and space heating are “low value” products.

Thus, embodiments of the invention will yield a cost-effective (low-capital cost), relatively low-tech way (with few moving parts) of delivering deeply chilled air to the turbine's front-end compressor, with very little pressure drop and without ice build up. The colder the air, the denser it is, the less work will be required from the front-end compressor, allowing more of the power output of the hot gas expander to be sent to the generator (the power producing part of the complete assembly), all of which may spin on the same shaft. That total power output, through the generator, can nearly equal the output of the hot gas expander minus the work required to compress the inlet air. Because of the reduced pressure drop in the cold flue, the cold inlet air will arrive at the compressor flange at approximately 14.3 psia, which allows compression and expansion ratios that are “comfortable” for most air-bearing turbines.

An alternative embodiment includes the use of air conditioning return air to provide a pre-cooling function to the turbine. Specifically, a portion of the return airstream that is exhausted by the air conditioning system is sent to the top of the cold flue assembly. In another alternative embodiment, the return air stream is delivered to a below-grade vault that would house the insulated cold flue within a geothermal “cold box.” The underground cylindrical cold box would act as a low-tech heat exchanger that would contain and surround the more refined cylindrical cold flue, thus creating a heat exchanger within a heat exchanger. The inlet air to the cold flue would be further cooled in the cold box by several low-tech cooling methods, including heat exchange with the surrounding cool earth, receipt of recycled air from an air conditioning system, or nearby cold water pipes.

Alternative embodiments use available deep refrigeration (through cold recovery) at sites with processes that vaporize cryogenic liquids, such as, but not limited to, Liquid Natural Gas (LNG), liquid oxygen, liquid nitrogen, and liquid argon, where the recovered cold can substitute for the work of the absorption chiller, and where the waste turbine exhaust is used to vaporize (and warm) the cryogenic fluid. The cryogenic fluid could also be used as a portion of a fuel stream to the combustion chamber. Such sites would include hospitals and smaller steel mills that vaporize liquid oxygen and off-pipeline power plants that use Liquid Natural Gas as a fuel. Another cold recovery integration that can provide pre-cooling to the VCCP Cycle, where a cryogenic liquid is routinely vaporized, is at LNG import terminals that convert LNG to warm, vaporized compressed natural gas, suitable for pipeline insertion. Other embodiments include the use of naturally occurring and/or adjacent man-made sources for pre-cooling the air flow into the cold flue, so as to enhance the effect of the absorption chiller; and the use of adjacent man-made sources of waste heat to enhance the operation of the waste-heat-driven absorption chiller, allowing it to deliver deeper refrigeration at the bottom of the cold flue.

The VCCP Cycle, when applied to micro- and mini-turbines can be used in Distributive Generation (DG) applications. The power produced would be used to supplement (or replace) power purchased from the electric grid, especially during peak demand periods, when grid-power is most expensive. In general, DG has several goals, including the following: Reducing losses through the power transmission system; reducing demand charges to the customer; allowing end users to be certain that none of the power purchased is from coal fired power plants; diminishing the need to build costly power grid extensions or upgrades.

The use of the VCCP Cycle as a DG power plant would be especially appropriate where much of the VCCP power output is dedicated for a particular purpose, such as powering the Air Conditioning (AC) system in an office building, shopping mall, or other large building; or to power the refrigeration system in a food processing facility; or in a hospital where modern imaging technology depends on deeply chilled magnets and the like; or at large computer facilities which require significant refrigeration systems to counteract the heat produced by the micro-processors.

The VCCP Cycle, by providing electric power that is independent of the electric grid, can also serve as a back up generator. However, unlike standard back up generators that rely on engines as the prime mover, and require stored diesel fuel as the energy source, the VCCP Cycle typically relies on pipeline delivered natural gas. As such it eliminates the need for on-site fuel storage and avoids the possibility of fuel leaks and ground contamination. The VCCP power plant will produce power that is substantially more efficient than standard diesel-driven engines and all other equivalent-sized turbines. As such the emission profile of the VCCP Cycle will be good enough to allow it to function all the time, and certainly during peak power demand periods, when power from the grid is most expensive. Thus, the VCCP Cycle can replace back up (emergency) generator systems and, at the same time, provide a “peaking” plant, which will help reduce “demand charges” that accrue to users that purchase grid power during the highest value peak demand periods. It should be understood that all turbines (including in the VCCP Cycle) are quite flexible with regard to the fuel used, and will tolerate other gases, such as landfill gas, anaerobic digester gas, coal-bed methane, propane, and a variety of atomized liquids, including gasoline and diesel, as well as various bio-fuels.

The likelihood of an electric outage occurring simultaneously with a natural gas outage, or the breakdown of the VCCP Cycle power plant, is extremely rare. Thus, the VCCP Cycle (DG) power plant can also be the exclusive emergency/back-up generator. Its main function would be to provide power, for example to the AC system. The VCCP Cycle would switch to providing “critical” power during a power outage on the grid, or when the utility requests cutbacks. Such critical power demanding equipment would include elevators, water pumps, and other such sub-systems. A single VCCP power plant would serve a daily function of providing DG, as well as an emergency generator function.

The Cold Flue and other aspects of the VCCP Cycle also may be integrated with air compressors and in natural gas compressors, substantially improving the efficiency of those machines. For example, all of the world's natural gas pipelines require large booster compressor, placed at predictable intervals along the pipeline, to maintain the design pressure within the pipeline. The VCCP Cycle's application to such gas-fired compressors can yield significant fuel and emission reductions at such pipeline compressor stations.

Embodiments of the present invention can be used in mobile applications in the transportation sector, starting with larger vehicles (ships, locomotives, trucks and buses), and moving on to smaller vehicles such as passenger cars. In the simplest model, the VCCP Cycle would (using any fuel) produce electricity (kW) that would drive motors that move the wheels on a locomotive, bus or truck (or ship propeller), and would also charge the batteries that would provide the start up power and provide peak power (say uphill). The benefit of such an application would be similar to the benefits of hybrid cycles, where, for example, breaking power could be recovered to charge the batteries. The VCCP Cycle prime mover would operate at a “steady state” providing the highest efficiency per unit of fuel used, allowing each motor that received the power output from the prime mover to respond to the specific power demand (torque) at each wheel. In other words, the standard “transmission” between the prime mover and the wheels would be eliminated, and the prime mover (the VCCP Power Plant) would always run at its most efficient state, regardless of the amount of power sent to the motors that drive the wheels.

Embodiments of the present invention can be installed as part of an Original Equipment Manufacturer's (OEM's) product, or as a retrofit onto existing gas-fired turbines. The retrofit option would offer benefits, even if the existing turbine were horizontally configured. In the OEM version, the entire assembly can be optimized for efficiency, and the operating pressures of the OEM turbine can be set to better suit the widely available natural gas pressures found in local pipelines. The vertical orientation offers no drawbacks to the construction, field erection, or maintenance of the turbine. Of course, embodiments of the present invention can be used with standard, horizontally-arranged turbine systems.

Thus, embodiments of the present invention provide energy efficiency by delivering the coldest possible dense inlet air to gas-fired turbines, with the least possible pressure drop, and with no possibility of icing, thus substantially improving the efficiency of the turbine, allowing it to produce its rated output at all warm-weather conditions, and reducing its emissions per kWh of power output and reducing the totality of waste heat sent to the surrounding context. These and other features and advantages of the present invention will be appreciated from review of the following detailed description of the invention, along with the accompanying figures in which like reference numerals refer to like parts throughout.

### BRIEF DESCRIPTION OF THE DRAWINGS

The foregoing and other objects of the invention will be apparent upon consideration of the following detailed description, taken in conjunction with the accompanying drawings, in which:

FIG. 1 is a process diagram of an embodiment of a power system in accordance with the present invention;

FIG. 2A is a vertical cross-section view of a cold flue assembly in accordance with the present invention;

FIG. 2B is a horizontal cross-section view of the cold flue assembly of FIG. 2A;

FIG. 3 is a process diagram of an embodiment of a power system in accordance with the present invention; and

FIG. 4 is a process diagram of an embodiment of a combined cycle power system showing a retrofit system in accordance with the present invention; and

FIG. 5 is a process diagram of an embodiment of a power system in accordance with the present invention showing liquid natural gas as a source of refrigeration.

FIG. 6 is process diagram of an embodiment of a power system retrofit assembly in accordance with the present invention showing a vertical cross-section view of an embodiment of the cold flue assembly.

FIG. 7 is a process diagram of an embodiment of a power system in accordance with the present invention showing deployment at a non-pipeline gaseous fuel facility.

### DETAILED DESCRIPTION

In the following paragraphs, embodiments of the present invention will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations on the present invention. As used herein, the “present invention” refers to any one of the embodiments of the invention described herein, and any equivalents. Furthermore, reference to various aspects of the invention throughout this document does not mean that all claimed embodiments or methods must include the referenced aspects. Reference to temperature, pressure, density and other parameters should be considered as representative and illustrative of the capabilities of embodiments of the invention, and embodiments can operate with a wide variety of such parameters.

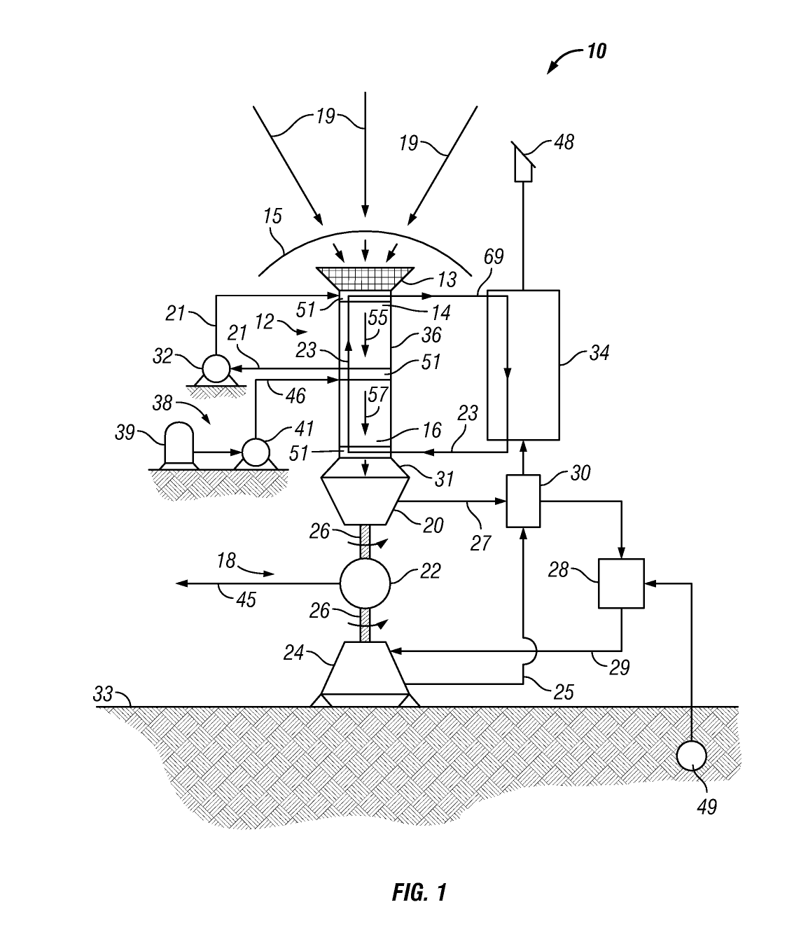

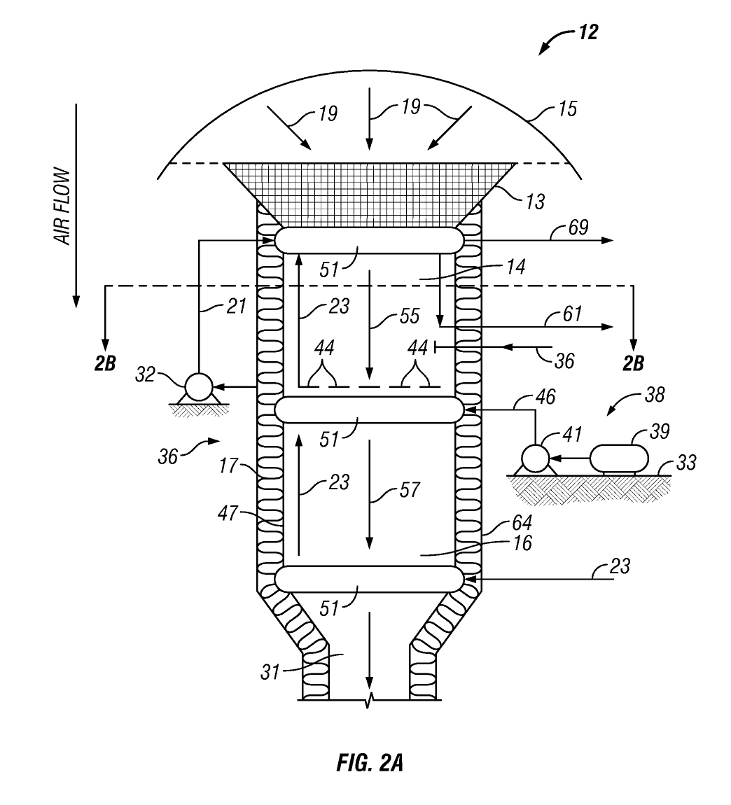

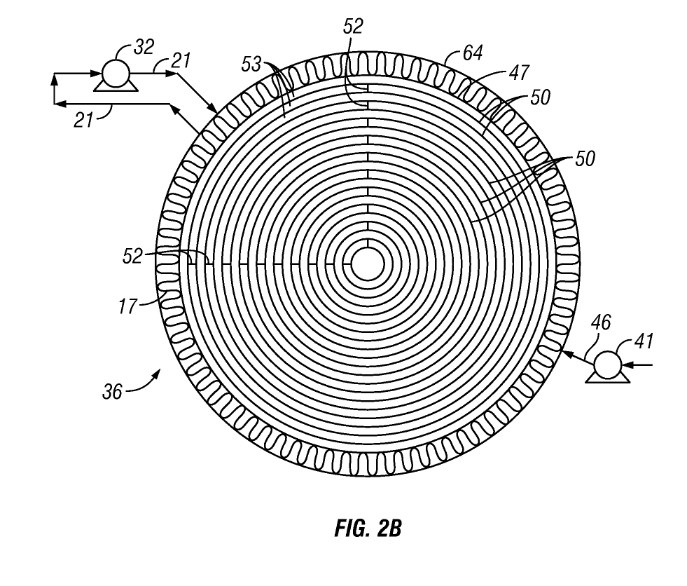

Referring to FIGS. 1-2B, an embodiment of the power system of the present invention is shown. Power system 10 comprises cold flue assembly 12 having a top 14 and a bottom 16 and turbine assembly 18. The power system is preferably a simple cycle power system. Turbine assembly 18 comprises air compressor 20, generator 22 and hot gas expansion turbine 24, components that are well understood in the mature technological field of gas-fired turbines. The power output from the generator is shown as stream 45. When referring to the turbine assembly, the terms “hot gas expansion turbine” and “expander” will be used interchangeably. In some embodiments, the power system is a mini-turbine or micro-turbine power plant. Micro-turbines typically have a rated output of 100 kW or less, while mini-turbines may have a rated output of, e.g., between 100 kW and 1,000 kW (1 MW). Both are distinct from larger simple cycle gas turbines at above 1 MW and from Combined Cycle Power plants with total rated output of hundreds of megawatts. The turbine assembly may be on a single shaft 26 and may operate in a vertical configuration such that the plane of rotation of the air compressor, the generator and the hot gas expansion turbine is parallel to the ground. Air compressor 20 is located directly below cold flue assembly 12 and is connected to the cold flue assembly, e.g., by nozzle connector 31, which may vary in design depending on the width of the cold flue relative to the inlet air point of the compressor. Thus, the falling cold, dense air will not need to change direction from its vertical drop through the cold flue to a horizontal path as it enters the compressor, eliminating another point where pressure drop might occur. The system further comprises combustion chamber 28 and recuperator 30, which are each connected to expander 24, and pipeline natural gas supply 49. Absorption chiller assembly 34 is connected to recuperator 30 and to cold flue assembly 12. As will be described in more detail herein, absorption chiller assembly 34 provides refrigerant to the cold flue assembly. Absorption chiller assembly 34 may include a cooling tower to dissipate low-grade waste heat into the surrounding environment. It also should be noted that various pumps, connectors, valves, sensors, gauges and fire suppression systems are not shown, but would typically be included in any engineered product of this nature.

Cold flue assembly 12 includes a plate fin heat exchanger 36 and may be enclosed in a suitable shell 47, insulating material 17 and outer shell 64 to protect the insulating material 17, with inlet and outlet stream systems as described in more detail herein. As can best be seen in the cross-section view of FIG. 2B, in one embodiment, the cold flue assembly, and specifically the plate fin heat exchanger, is configured in a vertical manner (with the plates 50 in an optimum, such as concentric circle, arrangement) so that the entire assembly resembles a round “flue” and air enters the top and falls to the bottom. The circular configuration of the cold flue assembly provides the largest area (in plan) and the greatest volume (at any specific height) with the least surface area on the outer perimeter of the cold flue, thus reducing the potential for heat gain. Vertical, circular plates 50 are supported by manifolds 51 disposed in plate fin heat exchanger 36 at the top and bottom, and optionally at one or more intermediate levels. The concentric circle configuration of plates 50 creates large contact surfaces for the three counter-flowing streams (refrigerant, air, and recovered cold water at the top section), but without an excessive number of corners, thus avoiding unnecessary pressure-drop, and achieving a close temperature approach between the air and refrigerant streams, without the need for an excessively large heat exchanger. This concentric circular design, with vertical flow, creates chambers 53 for air flow and will assure that all of the air will move across all surfaces in the smoothest possible way aided by gravity. A more uniform movement will allow more evenly distributed contact between the falling air and the surfaces within the heat exchanger.

In some embodiments, the plates 50 in the concentric circle heat exchanger (cold flue) are like barrels within barrels, with a manifold at the top and bottom to hold them in place. They are separated by fins 52. Manifolds 51 allow the various fluid streams to enter and exit the top, middle and bottom of cold flue assembly 12. The internal design of the heat exchanger, including the arrangement of plates 50 and fins 52, the relationship of the resulting chambers, and the selection of which fluids are in which chamber can vary considerably based on the engineer or manufacturer's goals. The configuration of the fins determines how the various fluids move through the heat exchanger (cold flue), and are designed for the maximum effect of heat conduction between the fluids, which are separated from each other by the concentric plates 50. Instead of a normal flue that efficiently allows hot gases to rise to the top of the flue by “stack effect”, here ambient air 19 enters the top of cold flue assembly 12 at atmospheric pressure (14.7 psia) and warm temperatures (say, as warm as 95° F.), laden with as much as 55% relative humidity, and the “cold flue” design allows the chilled air to fall from the top, where it enters the flue and continues falling by gravity as it is chilled in the cold flue, increasing its density as it falls deeper into the flue, and reaching the inlet to the compressor flange at sub-zero (F), with very little pressure drop, without the need for electric powered blowers and fans to move it along. This may be a minor point for air that is only cooled to 35° F. However, at heat exchanger exit temperature of −10° F. (and possibly colder) the effect of gravity on the denser air is not insignificant.

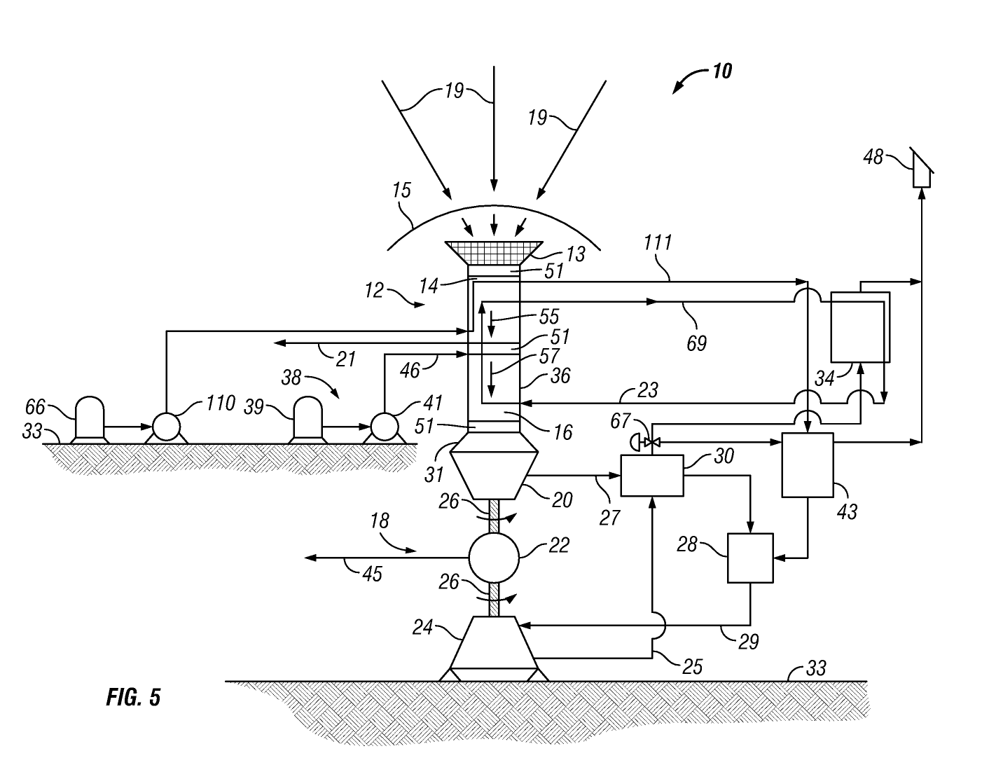

It should be noted that the benefits of cooling the inlet air to −10° F. will accrue in cold climates as well. Furthermore, if the ambient air that enters the top of the cold flue 12 in cold climates averages 0° F., then the waste heat driven by absorption chiller 34 will produce −20° F. inlet air, (because it only needs to cool the inlet air from 0° F. to −20° F., rather than 95° F. to −10° F.), and will do so while using less of the waste exhaust heat. In that context, the remaining waste heat can be used to warm the fuel stream, as will be described herein in connection with FIG. 5.

The vertical configuration of the aluminum plate fin heat exchanger will achieve the close temperature approach that plate fin heat exchangers are known for, in a relatively small height, with very little pressure drop, The most efficient, and thus the preferred heat exchangers for close approach temperatures are plate fin, brazed aluminum heat exchangers. The design parameters and construction processes for such heat exchangers are a well understood, mature technology. Although brazed aluminum is the preferred material, other materials known in the art may be used. The height of the cold flue will be dependant on the chilling duty (stream sizes) for which it is designed, and will be proportional to its diameter. The diameter of the cold flue will be dependent on the stream sizes, the cold flue's height, and the optimization of those dimensions along with the selected number of chambers for fluid flow.

To keep the flue free of falling debris, the opening on the top of cold flue assembly 12 may have filter 13, and optionally, a cover 15 that would keep large objects, rain, sleet, snow, hail, leaves, and animals from entering the flue. Such a system would aim to allow the free flowing of the ambient air, which would move through the air filter 13 by the natural atmospheric pressure, with as little pressure drop as possible, while screening out all larger-than-air components of the air stream, such as dust, small insects, pollen, etc. Devices such as those that cap standard chimneys might be used as a “cover” at the inlet. Cold flue assembly 12 may also comprise insulating material 17 to keep out heat gain. The insulating material may be fiberglass batting, or more sophisticated insulation such as blankets containing microspheres, or any other insulating material known to those of skill in the art. It should be noted that, in various embodiments, it is preferred to insulate all hot and cold components. There also may be an outer shell 64 to hold the insulation in place. Outer shell 64 may be any suitable material that is light-weight, weather resistant, light color (such as white) to reflect solar gain, and which can be sealed at its seems so that it can protect the insulation from moisture intrusion.

As shown in FIG. 2A, cold flue assembly 12 may include one or more condensation plates 44, i.e., drip pans, at an intermediate point in the interior of the assembly, where the moisture content of the air is condensed, (say, at the point where the air is cooled to 35° F.), and where 90% of that moisture leaves the cold flue as 35° F. water. (That cold water will be recycled, first through cold recovery, and then in the make-up water stream of the absorption chiller's cooling tower.) The condensation plates 44 preferably are arranged in a near horizontal mode, so that when the cold air hits the plates water condenses on them.

The condensed moisture in the partially cooled air stream can be collected in condensation plates 44, such that the condensed water flows out of the flue before it freezes, and allows the mostly dry air to continue falling. Specifically, the condensation plates are slightly tilted so that the water runs out toward a collection point, and leaves the cold flue, gets pumped and then is sent (cold) to the top of the cold flue assembly. That cold condensed water stream 21 can be pumped by water pump 32 to the upper portions of the plate-fin heat exchanger as a third stream and circulated therein. It would supplement the cooling effort of the main refrigerant (which will be relatively warm by the time it arrives at the top of the flue), helping to cool the warm air that enters the top of the cold flue assembly. Once the cold in the water has been recovered, the warmed water, e.g., 70° F., could be sent to the cooling tower that helps dissipate the low-grade waste heat of the absorption chiller.

Some of the functionality of embodiments of the power system will now be described. Hot gas 29 is sent to hot gas expansion turbine 24, where it is expanded to approximately 15.50 psia, at an expansion ratio of 3.74 to 1.0. Compressed air 27 from air compressor 20 is directed to recuperator 30. Specifically, the 15.50 psia exhaust pressure will allow the hot exhaust stream 25 to travel from expander 24 through the recuperator. The recuperator is a heat exchanger that has two streams through it: the compressed air from the front end compressor portion of the mini-turbine assembly, and the hot exhaust gas being sent out of the hot gas expander portion of the mini-turbine assembly. In other words, the recuperator is the heat recovery portion of the system, and can be as productive in recycling waste heat to the compressed air flow as is economically and technically possible. The power plant designer has a great degree of flexibility regarding recuperator efficiency. Instead of aiming for the most efficient recuperator, at the highest cost, the designer might settle for a slightly less efficient design, at a substantial capital cost saving, because any unused exhaust heat that will not be used in the recuperator will be useful in the absorption chiller. For example, a recuperator efficiency of 80% (instead of 90%) might yield a 50% savings in the cost of the recuperator because of the reduced total surface area within the heat exchanger. However, the extra cooling available from recovered heat from an 80%-efficient recuperator can compensate for its reduced efficiency.

Recuperator 30 warms the compressed air by heat exchange with a hot exhaust stream from hot gas expansion turbine 24. The warmed compressed air is directed to combustion chamber 28. At least some waste heat from the hot gas expansion turbine's exhaust stream that warmed the compressed air in recuperator 30 is directed from the recuperator to absorption chiller 34. After the maximum practical amount of waste heat is re-used within the turbine's recuperator it would be sent to absorption chiller 34. The absorption chiller will receive the exhaust stream at approximately 500° F., depending on the size of the turbine, the efficiency of its components, and the heat content of the fuel. The 15.50 psia exhaust pressure further allows for pressure drop through the absorption chiller. The waste heat provides energy to the absorption chiller to produce refrigeration.

The absorption chiller is designed to use as much of the remaining waste heat as is practical. Absorption chillers transfer thermal energy from natural gas, steam, or waste heat to a heat sink through an absorbent fluid and a refrigerant. For example, an absorption chiller might absorb and then release water vapor into and out of a salt solution. Heat is applied at a generator and water vapor is driven to a condenser. The cooled water vapor passes through an expansion valve and undergoes a reduction in pressure. The low-pressure water vapor then enters an evaporator. In the evaporator, ambient heat is added from a load and the cooling occurs. The heated, low-pressure vapor returns to the absorber, where it recombines with the salt and becomes a low-pressure liquid. The low-pressure solution is pumped to a higher pressure and into the generator to repeat the process. Lithium Bromide and Ammonia are common refrigerants used in absorption chillers. The former yields moderate levels of refrigeration, while the latter yields deeper (colder) refrigeration. Their selection will depend on the heat content of the waste heat source.

After exiting absorption chiller 34, the waste heat then moves to its final “exit point” which is hot flue 48. In most configurations, the upward moving exhaust stream that exits the hot flue need not be warmer than, e.g., between 200° F. and 125° F. Thus, the absorption chiller will benefit from the delta between 500° F. exhaust stream that enters the chiller and the cooler exhaust stream that leaves it. The volume of the exhaust will be approximately equal to the total volume of inlet air and the volume of fuel (say, at a ratio of 97% to 3%) accounting for the chemical changes during combustion and for the very small amount of water and antifreeze (ethanol) in the inlet stream. All of the available waste heat (not required for the proper operation of the hot exhaust flue and any emission reduction devices), could be used to generate refrigeration in the absorption chiller. In a 250 kW system, for example, the absorption chiller will produce approximately 55 tons of refrigeration (TR) where the refrigerant enters the heat exchanger at −15° F. The goal is to achieve the coldest possible refrigerant temperature with all of the available, relatively low-grade heat.

Absorption chiller assembly 34 directs a pumped to pressure refrigerant 23 into cold flue assembly 12. The refrigerant can be ammonia, lithium bromide, or other refrigerant substances known to those in the art. The refrigerant rises within the cold flue assembly and through heat exchange cools the air as the air falls within the cold flue assembly. The cooled air falls through the bottom 16 of the cold flue assembly and into air compressor 20. The fundamental goal of delivering the coldest possible inlet air to the turbine is to increase the ΔT between the cold inlet air and the hot gas that is expanding. The present invention will yield a greater ΔT than other existing options, but will operate within the laws of thermodynamics. The symbol “ΔT” stands for the temperature gap between the cold and warm ends of the cycle, such as the delta between T1 and T2. The Maximum Thermal Efficiency=(T2−T1)/T2 where T2 is the firing temperature of the turbine and T1 is the inlet air temperature. Embodiments of the invention can yield thermal efficiency of at least 42.9%, and an electrical efficiency of at least 38.0% with a fuel consumption of about 9.96 SCF/kWh.

Some embodiments of the system may include an antifreeze delivery system 38 to prevent icing within the heat exchanger. The antifreeze delivery system may include antifreeze tank 39 and antifreeze pump 41 to facilitate delivery of the antifreeze to the cold flue assembly. An atomized antifreeze stream 46, such as ethanol or ammonia, may be sprayed into the falling, cooling air stream in cold flue assembly 12 so the remaining water, around 10%, will not freeze and cause the cold flue to ice up as the air falls further down. The selected antifreeze will be soluble in water, thus dissolving in the remaining moisture and allowing that mixture of water and antifreeze to burn in the turbine's combustion chamber without releasing any unwanted emissions. The antifreeze also will not attack the aluminum plates in the heat exchanger. The selected antifreeze (e.g., ethanol, other alcohols, or ammonia) will arrive at the turbine's combustion chamber ready to be burned up, much like the natural gas fuel, so that none of it will be released unburned to the atmosphere. The cost of that antifreeze will be somewhat offset by its heat content, which is retrieved during combustion.

The antifreeze preferably is introduced as an atomized spray, into the partially cooled but mostly dry air that falls beyond the condensed water drip pan. The antifreeze would be held in a tank 39 that would be periodically re-filled, and would be pumped to the appropriate pressure by a small antifreeze pump 41, which would require very little power. The antifreeze storage tank 39 and the make-up rate should be relatively small because only a small amount of ethanol will be required to keep the relatively small amount of water in the air from freezing. Approximately 10 gallons of antifreeze will be required per day in a 250 kW power plant. Because of its small volume, the antifreeze stream can be at ambient temperature, without any significant impacts on the chilling duty of the cold flue.

Referring again to FIGS. 2A and 2B, the fluid pathways during operation can be seen. Reference number 19 represents the air flow entering the top of the cold flue assembly, dropping down toward the air compressor. Reference number 55 represents the air in the top half of the cold flue assembly 12, cooled by the cold condensed water stream, with most of its moisture content dripping out (condensing) and falling to the condensation plate(s). Reference number 57 represents the air in the bottom half of the cold flue assembly 12, further cooled by the rising cold ammonia stream and containing atomized antifreeze that is soluble in the remaining moisture content of the air. Reference number 21 represents the cold condensed water stream moving from a pump to the top of the cold flue, in insulated piping. Reference number 61 represents warmed condensed water, having absorbed heat from the falling air, leaving the cold flue, on its way to a cooling tower that serves the absorption chiller. Reference number 46 represents the pumped stream of antifreeze (e.g. ethanol) on its way to an intermediate level manifold for spraying into the cooling air stream. Reference number 23 represents refrigerant (cold ammonia), arriving pumped to pressure from the absorption chiller. The ammonia refrigerant 23 rises, absorbing heat from the falling cold air. The ammonia refrigerant 23 continues to rise through the top half of the cold flue, somewhat warmer, absorbing heat from the falling air stream. Reference number 69 represents warm ammonia leaving the cold flue, returning to the absorption chiller for refrigeration and pumping, so that it can be sent back to the cold flue.

The insulated cold flue can achieve an approximately 5-degree “approach” between the, e.g., −15° F. counter-flowing refrigerant, moving “up” under moderately pumped pressure, and the cold air that is chilled to an exit temperature of, say, −10° F. at the bottom of the flue. The insulation of the cold flue (with super-insulation, such as micro-spheres) is required so that the conditions inside are not diminished by warmer outside conditions. This will limit heat gain to the system as much as practical. Inlet air temperatures to the turbine's compressor can be −10°F. However, given the modern materials used in compressors, including aluminum alloys, much colder temperatures likely could be achieved. With cold recovery from adjacent cryogenic processes, the inlet temperature to the compressor can be −50° F. and colder, yielding proportional increases in efficiency and proportional decreases in fuel use and emissions.

The drop in air temperature causes the air to increase in density as it falls through cold flue assembly 12. The first column in the table below shows the density of ambient air at 0.0696 pounds per cubic foot, at a pressure of 14.5 psia (just under atmospheric) and at 95° F. with a relative humidity of 55%. Subsequent columns show the increasingly chilled air with very little moisture content (but at 100% of its capacity to contain moisture), increasing in density as the air's temperature drops.

Wet Air density (at 14.5 psia)

| | | | | | |
|---|---|---|---|---|---|
| Temp, F. | 95 | 35 | 0 | −10 | −15 |
| R.H., % | 55 | 100 | 100 | 100 | 100 |
| Density, | 0.0696 | 0.0788 | 0.0850 | 0.0870 | 0.0880 |
| Lbs.Ft3 | | | | | |

An advantage of embodiments of the present invention is that denser air requires less power to compress than “looser” air; and the volume of air (the O2 stream) to the turbine's combustion chamber 28 can be reduced when that flow is denser (has a higher O2 content), thus reducing the quantity of air that the compressor 20 needs to compress. Note that the density increase is directly proportional to the temperature decrease after the moisture content of the air is removed at just above freezing. At −15° F. the density of air is 126% of the density of air at 95° F. This is very helpful in allowing the “heavier” air to fall toward the compressor 20, without an excessive pressure drop, and will requires less work on the part of the compressor to achieve the target pressure of 60-psia. The reduced compressor workload stems from two mutually supporting factors: the entire assembly operates at a relatively low temperature; and because of the reduced pressure drop in the cold flue, the cold inlet air will arrive at the compressor flange at approximately 14.3 psia.

In turn, that allows the compressor to perform a comfortable 4.2 to 1.0 compression, yielding 60-psia-air that is sent on through the recuperator to the combustion chamber, where it mixes with 60-psia-fuel. The resultant hot gas would be sent to the hot gas expander portion of the turbine, where it would be expanded to approximately 15.50 psia, at a ratio of 3.74 to 1.0. The 15.50 psia exhaust pressure will allow the exhaust stream to travel through the recuperator and the absorption chiller, allowing for pressure drop through those devices, and still having enough pressure to exit the flue at 14.7 psia. Those compression and expansion ratios are “comfortable” for most air-bearing turbines. More importantly, 60-psia is more common in local natural gas pipelines than higher pressures. If the pressure-drop is too significant, the benefit of the dense air will be partially lost, because the compressor would need to do more work to bring the low-pressure inlet air up to the design pressure (say, 60 psia) of the turbine.

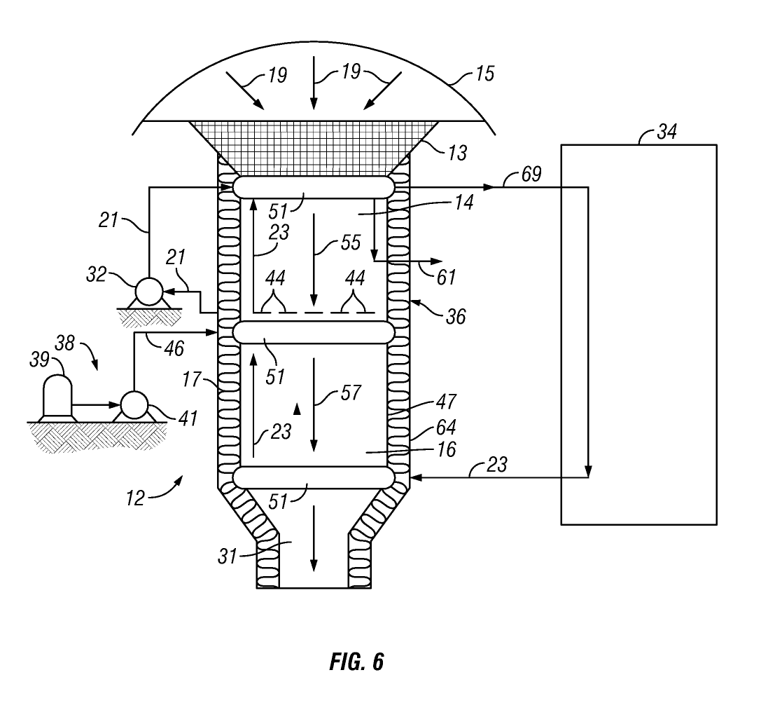

It should be noted that embodiments of the invention can be made as a retrofit system for a simple cycle power plant, as shown in FIG. 6. A retrofit assembly comprises cold flue assembly 12 that operates in a vertical configuration and has a top 14 and a bottom 16. Cold flue assembly 12 includes a plate fin heat exchanger 36 and may be enclosed in a suitable shell 47, insulating material 17 and outer shell 64 to protect the insulating material 17. Cold flue assembly 12 may include one or more condensation plates 44 arranged in a near horizontal mode, so that when the cold air hits the plates water condenses on them. The condensed moisture in the partially cooled air stream can be collected in condensation plates 44, such that the condensed water flows out of the flue before it freezes, and allows the mostly dry air to continue falling. That cold condensed water stream 21 can be pumped by water pump 32 to the upper portions of the plate-fin heat exchanger as a third stream and circulated therein. Absorption chiller 34 is connected to cold flue assembly 12 and provides refrigerant 23 to the cold flue assembly. The refrigerant 23 rises within the cold flue assembly 12 and cools the air as it falls within the cold flue assembly. As described in detail above, absorption chiller 34 is configured to receive at least some waste heat from the simple cycle power plant and use that waste heat for power. The retrofit system as shown in FIG. 6 could be integrated with a simple cycle power plant having a turbine assembly comprising an air compressor, a generator and a hot gas expansion turbine such that the air compressor is located directly below the cold flue assembly and connected thereto. The retrofit system could be attached to an existing turbine assembly configured either vertically or in the traditional horizontal arrangement, which also may include a combustion chamber and recuperator. Once integrated with the existing power system, the retrofit would operate as the other embodiments that have been described herein, i.e., such that a recuperator warms compressed air, the warmed compressed air is directed to the combustion chamber, and at least some waste heat from the hot gas expansion turbine's exhaust stream is directed from the recuperator to the absorption chiller to provide energy to produce refrigeration. The retrofit may also comprise an antifreeze delivery system and/or an air conditioning system as described herein.

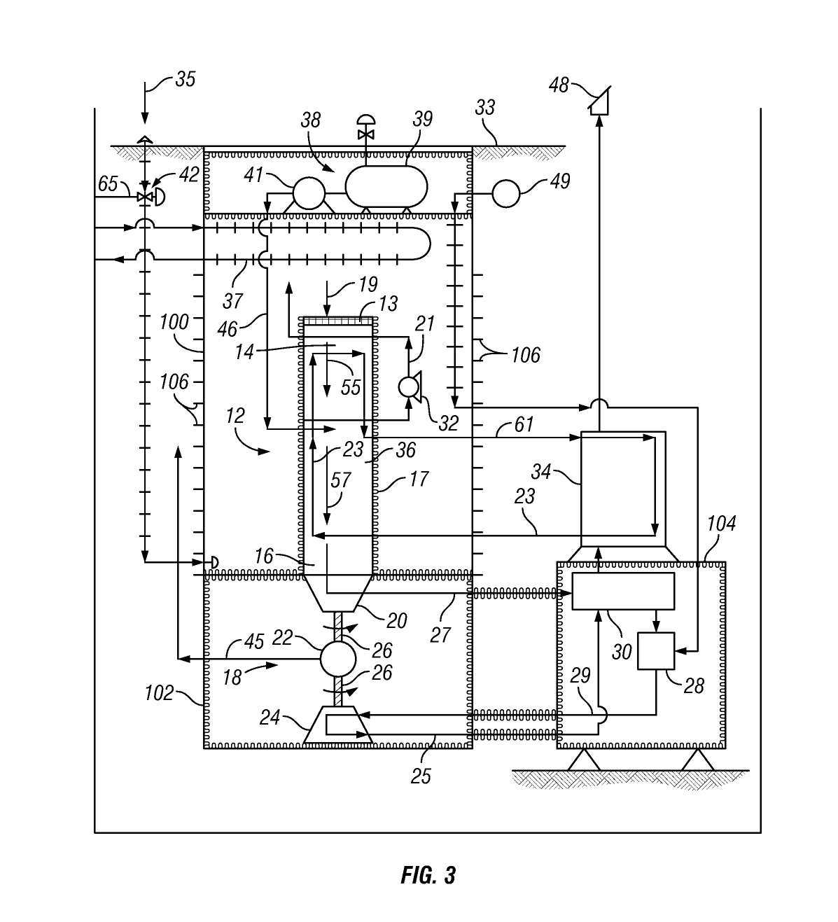

For turbines that serve as the distributive generation power source for an adjacent office building or large-scale retail or industrial use, the air conditioning system within that building can provide a pre-cooling function to the turbine, as can be seen, for example, in FIG. 3. In such embodiments, the portion of the return air stream 65 that is exhausted by the AC system, to allow fresh air intake, would be sent to the top of the cold flue assembly 12. That stream is likely to be closer to 78° F. than to the 95° F. ambient conditions, and will contain less water, and will be at a slightly elevated pressure. Those factors will significantly improve the effect of the cold flue, allowing the refrigeration from the absorption chiller to be directed at deeply cooling the pre-cooled falling air. Such an arrangement may allow the delivered air to the compressor to be colder than −10°F.

Embodiments of the invention can take advantage of many possible sources of pre-cooling of the inlet air before it arrives at the cold flue, including connecting an adjacent air conditioning system to the cold flue assembly and using the return air stream in the air conditioning system to cool the air prior to the air entering the top of the cold flue assembly. Such integration would be especially feasible where the VCCP cycle is used to provide power to drive the air conditioning system. As will be described herein with reference to FIG. 3, other options are to locate the cold flue within an underground “vault” that uses geothermal cooling to cool the air within the vault; supplement that geothermal cooling by the chilling effect of an array of cold water pipes that serves the adjacent building, thus creating a large-scale, low-tech, “coil wound” heat exchanger out of the “vault” that contains the cold flue; and utilize the available energy of “letdown” at sites where propane (stored at 200 psia) is used as the fuel. In the propane letdown embodiment, 200-psia propane (also known as LPG) would be sent through a throttle valve, where it would exit at 60 psia, significantly cooling the propane. That refrigeration effect can be recovered in the cold flue and used to pre-cool the inlet air to the cold flue, allowing more of the absorption chiller output to be used for deeper refrigeration, but without using all of the available waste heat. In that manner, the use of propane as a fuel would be similar to the embodiment shown in FIG. 5, where the remaining waste heat is used to warm the fuel before it enters the combustion chamber. Both the LNG and LPG schemes are especially useful at off-pipeline locations where standard gas-fired turbines are not commonly used because of the lack of pipeline-delivered natural gas.

Another embodiment can employ cold recovery through a pressure letdown expansion device at high-pressure natural gas pipelines. Yet another embodiment of the power system described above can integrate LNG as the fuel with cold recovery from a cryogenic fluid, here the vaporized LNG 111 (shown in FIG. 5), such that the delivered cold air to compressor 20, by way of cold flue 12, can be pre-cooled by the vaporized LNG 111, helping the absorption chiller deliver deeply chilled air to the bottom of the cold flue (say, −20° F.). Other cryogenic fluids may be used, including, but not limited to liquid oxygen, liquid argon or liquid nitrogen. The waste heat from the hot gas expansion turbine exhaust stream 25 would be used to further warm the vaporized LNG 111 so that the natural gas vapor is delivered hot as a portion of a fuel stream to the combustion chamber. Stream splitting valve 67 is used to select the flow rate of expander exhaust by “splitting” expander exhaust stream 25, sending most of it to absorption chiller 34 and a smaller portion to heat exchanger 43. The split streams ultimately re-join, after giving up heat, into a single stream that exits at hot flue 48. The integration of LNG supply 66 and LNG pump 110 shown in FIG. 5 yields colder (denser) inlet air to the top of cold flue 12 and later to compressor 20, under the bottom of the cold flue. The waste heat that leaves recuperator 30 is used to warm the vaporized LNG 111 that has been partially warmed by the inlet air in cold flue assembly 12. In particular, heat exchanger 43 uses hot exhaust from recuperator 30 to warm the NG (formerly LNG), which has absorbed some heat from the dropping air in the cold flue assembly 12. Thus, the NG can enter combustion chamber 28 as warm as possible so it does not cool down the hot air stream traveling from compressor 20 through recuperator 30. Power output 45 from the generator 22 is in kW/MW. The benefit of this embodiment is that it allows LNG to be more competitive as an off-pipeline (clean) fuel, (especially for “distributive generation” power plants) because the extra cost of LNG production and transport (in trucks) is mitigated by the cold recovery in the VCCP Cycle. The resultant deeply chilled inlet air will yield even higher efficiencies of power production than the basic VCCP cycle attached to a standard natural gas pipeline, and will allow some of the waste heat of the exhaust stream from hot gas expansion turbine 24 to be used for warming of the fuel stream. Other heat sinks, such as oceans, lakes, rivers, underground streams, natural caverns, and the surrounding earth, can also be used to good effect in pre-cooling the inlet air to cold flue 12, where the warming of the heat sink would be virtually imperceptible, but where the cooling of the inlet air to the turbine (directly or through a working fluid) would be significant. It should be noted that all hot and cold components should be appropriately insulated to avoid heat gain to cold elements and heat loss from hot elements.

Alternatively, where some portion of the exhaust stream 25 is not required by absorption chiller 34, the remaining waste heat can be used not only to heat the fuel stream, but also to heat the condensed and pumped water that is recovered from the top 14 of cold flue assembly 12 (after it picks up the warmth of the incoming air), producing 60 psia water vapor (steam). The 60 psia steam would then be sent to the stream of compressed air 27 that exits compressor 20, substituting for a portion of the air stream that would be dropping down the cold flue. The total volume of the stream of compressed air 27 would be the same but the work required to bring that stream to 60 psia would be less, because a portion of the stream (the steam portion) would become 60 psia without the need to be compressed. The less air that needs to be compressed by 20, the more net power is produced by generator 22. Additionally, the lower the air inlet stream to compressor 20, the colder and denser it will be when it enters compressor 20, and/or requiring less of the waste heat to be used for refrigeration in the cold flue 12, and allowing more of it to be used to produce the steam.

Turning to FIG. 3, an alternative embodiment includes the above-outlined use of AC return air for pre-cooling where some of the components are located in one or more housings, which may include at least one cold box 100, first hot box 102 and second hot box 104. As such, the return air stream is delivered to a below-grade housing that would house the insulated cold flue assembly 12 within a geothermal cold box 100. The cold flue assembly comprises all of the features and internal components described above, and the power system performs waste heat recovery and inlet air chilling by the mechanisms described in detail above. The cold box also may comprise one or more external fins 106. In this embodiment, turbine assembly 18 comprises air compressor 20, generator 22 and hot gas expansion turbine 24, which are housed in first hot box 102. Power output 45 from the generator 22 is in kilowatts (kW) or megawatts (MW) and the power system preferably is a mini-turbine or a micro-turbine. The first hot box is preferably located directly below and adjacent to cold box 100 so that air compressor 20 is directly below and connected to cold flue assembly 12. First and second hot box 102, 104 may be insulated so as to reduce heat gain to the surroundings. Combustion chamber 28 and recuperator 30 are housed in the second hot box 104, and the lines leading from the expander 24 and the combustion chamber 28 to the recuperator 30 have insulating material 17 so heat is not lost. The cold box 100 may be located underground, with the cold box 100 preferably at least four feet below ground level 33. The first hot box 102 also should be located underground because of its optimal location directly below cold box 100. The second hot box 104 may be located underground as part of first hot box 102 or adjacent to it, at least four feet beneath the ground, or it may be located above ground as shown in FIG. 3. Absorption chiller 34 is connected to the cold flue assembly 12 and recuperator 30 as described with respect to other embodiments, but the absorption chiller is not housed in a cold box or hot box. This embodiment also may comprise an antifreeze delivery system 38 to deliver antifreeze 46 to cold flue assembly 12. Waste heat from an adjoining waste heat source could be used to pre-warm the refrigerant in the absorption chiller, allowing more of the recovered heat from the prime mover's exhaust to achieve deeper refrigeration. It should be noted that this embodiment may comprise an air conditioning system connected to the cold box so the air in the cold box is further cooled by a return air stream 65 from the air conditioning system.

The inlet air to the cold flue could be further cooled in the cold box by several alternative cooling methods, including the following: the circular, (e.g., 4′ diameter, 7′ high, but other dimensions could be used depending on the desired application) geothermal cold box 100 may be located at least 4 feet underground, and would consist of corrugated galvanized steel or other non-corrosive metal, with external “fins” 106 to allow for maximum heat exchange with the surrounding cool earth. Cold box 100 could receive ambient air 35 or return AC air stream 65, allowing that air to also travel through a heat dissipating underground system that connects an adjacent building to the cold box. In the summer, stream selection valve 42 will choose the recycled air conditioned air stream 65, and in the winter it will select the cold ambient air 35. Cold box 100 could be further cooled by a heat sink, such as an array of uninsulated cold water pipes 37 (say, in a spiral configuration, along the outer edge of the cold box), such that the adjacent building's cold water demand would “travel” through the cold box, cooling the air within the box. Cold box 100 could also contain the uninsulated natural gas supply pipeline 49 run from the local natural gas line through the cold box, prior to the connection to combustion chamber 28, which would be in its own insulated “hot box” in an above-grade location. Other heat sinks, such as oceans, lakes, rivers, underground streams and natural caverns, can also be used to good effect in pre-cooling the inlet air to cold flue 12. The underground cylindrical cold box 100 would act as a low-tech heat exchanger that would contain and surround the more refined cylindrical cold flue, thus creating a heat exchanger within a heat exchanger. This embodiment can achieve at least 42% thermal efficiency.

The pre-cooling options offer a wide range of possible integrations with sources of cold, using various degrees of refrigeration (deep-, moderate- and low-grade) in a broad set of embodiments for the present invention. In other words, embodiments of the present invention offer a practical way to use “recovered cold” in on-site, distributive power production, recycling the inherent refrigeration energy normally wasted in a multitude of processes to significantly improve the thermal efficiency and the emission profile of power plants at all scales. Embodiments of the invention can also take advantage of all available cold recovery associated with processes that involve cryogenic fluids that are vaporized or otherwise warmed prior to their intended use. Many such processes can provide pre-cooling similar to the pre-cooling steps outlined above, and/or provide deeper cooling, beyond the refrigeration output limit of the absorption chiller. The present invention may be integrated with many such cold recovery systems; to achieve deeper chilling (approaching −50° F.) of the inlet air, where the compressor components are aluminum (as is common in air bearing compressors) or stainless steel, and which can tolerate such cold inlet air. That deeply chilled inlet air condition is well beyond the capacity of an absorption chiller, and will substantially improve the efficiency of the VCCP Cycle.

The following is a sampling of such integrations, where some embodiments of the cycle can provide especially efficient power because of the pre-cooling of the inlet air to the cold flue and the deep cooling of that air before it is delivered to the compressor: at steel mills where the liquid O2 is warmed up on its way to the steel processing; at hospitals where the liquid oxygen is vaporized to support the O2 distribution system; at facilities that vaporize liquid argon for process purposes; at facilities that use liquid N2 (such as cryogenic tire recycling plants) where cold N2 is now vented and thrown away; at LNG vaporization systems, such as found at peak shaving plants or LNG import terminals; at systems or processes where waste cold from liquid CO2 can be recovered; at other industrial system/process where cold (cryogenic, medium- or low-grade) is now routinely thrown away, and where distributive power generation with the VCCP cycle would take advantage of that cold recovery.

FIG. 3 and the supporting text and claims integrate the VCCP Cycle with an AC system, using a portion of the return air in the AC system as inlet air to the VCCP Cold Flue. Other, more sophisticated, integrations may allow AC systems and food processing refrigeration (and freezing) systems to improve their efficiency. The gas-fired VCCP Cycle would provide highly efficient power to the AC/refrigeration system, which in turn would provide pre-cooled air to the VCCP cycle, improving the total system's efficiency.

At larger-scale Combined Cycle power plants, retrofit or new, embodiments of the present invention can capture unused waste heat from the prime mover, convert that to refrigeration by way of an absorption chiller, which in turn would chill inlet air (that might have been pre-cooled) through a cold flue, delivering the cooled air to the front-end compressor at temperatures well below ambient, thus reducing the work load on the front end compressor and improving the overall efficiency of Combined Cycle power plants. At base-load Combined Cycle power plants, the pre-cooling of the inlet air may be accomplished by a variety of geothermal methods.

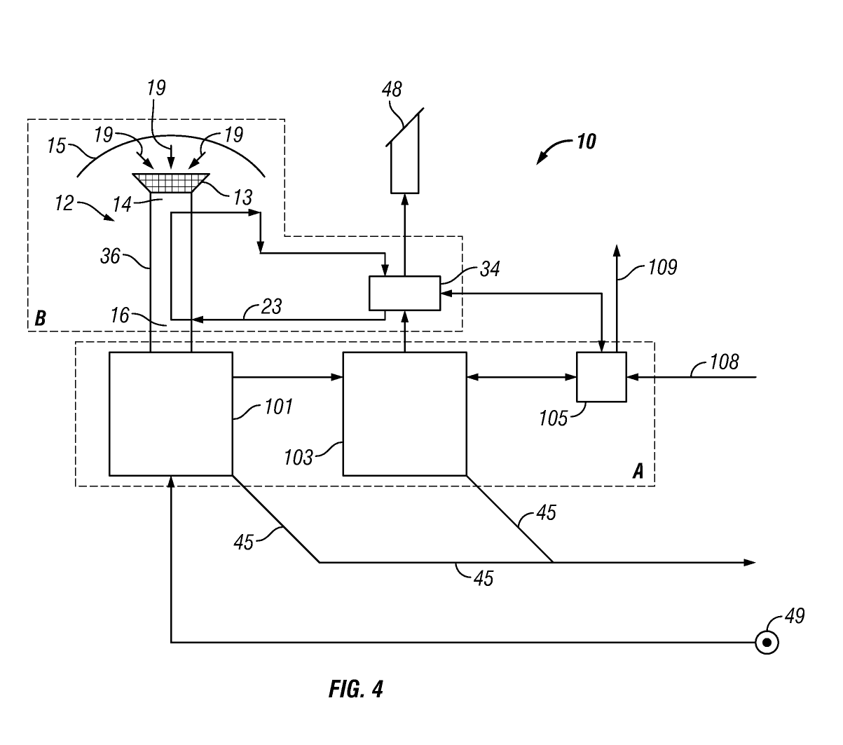

An embodiment of a retrofit system of the present invention is shown in FIG. 4 integrated with a combined cycle power system. The retrofit system comprises cold flue assembly 12 and absorption chiller 34, which are shown in dashed box B to indicate that they are the retrofit components. Cold flue assembly 12 has a top and a bottom and includes a plate fin heat exchanger 36. The cold flue assembly may comprise air filter 13 and cover 15 to keep out debris, as appropriate. The cold flue assembly operates in a vertical configuration, as described in detail above, such that air enters the top and falls to the bottom. Also as described in detail above, absorption chiller 34 is configured to receive at least some waste heat from the power system's exhaust stream and use the waste heat as energy to produce refrigeration. The absorption chiller directs pumped to pressure refrigerant 23 into cold flue assembly 12, and the refrigerant rises within the cold flue assembly and cools the falling air. The retrofit system may be integrated with combined cycle power system, which is a typical platform for the retrofit and is shown in dashed box A. The prime mover 101 of the power system includes the turbine assembly (not shown) as previously described and steam cycle 103. Prime mover 101 is connected to pipeline natural gas supply 49. Power output 45 from prime mover 101 and steam cycle 103 is in kW/MW.

This embodiment may also comprise a cooling tower 105. The purpose of a cooling tower is to dissipate low-grade waste heat into the surrounding environment, generally by evaporating water. Stream 108 is the make-up water to the cooling tower, from any available source, and stream 109 is the water (in a vapor state) that evaporates from cooling tower 105. The design, construction and operation of cooling towers are well understood and common to combined cycle power plants, refrigeration and air conditioning systems. However, due to the VCCP cycle's ability to condense the water out of the humid inflow air, by refrigeration in the cold flue, that recovered water, after cold recovery at the top of the cold flue, is sent to the cooling tower as a portion of the make-up water stream, thus reducing the water use of the cooling tower.

In the context of large Combined Cycle power plants, the waste heat may not be hot enough to drive an ammonia absorption chiller, but will be adequate to drive a lithium bromide absorption chiller which will produce approximately 30° F. refrigerant and approximately 35° F. inlet air. The more recovered heat is used to produce refrigeration and improve the power plant's efficiency, the less waste heat is spewed into the surrounding atmosphere. In such embodiments, with inlet air temperatures above freezing, the use of antifreeze in the cold air stream would not be required. In all other respects, including the vertical configuration of the cold flue and integration with passive heat sinks such as geothermal sources, embodiments of the present invention can be applied to existing and newly constructed Combined Cycle power plants. That embodiment would yield significant power production efficiencies. For example, if the most efficient Combined Cycle power plants, say, with thermal efficiencies of 59.6% (at ISO conditions) were upgraded with the cold inlet air delivery system outlined in the present invention, and received not the −10° F. inlet air available to smaller systems, but air cooled to only +35° F., their thermal efficiencies would improve to approximately 61.4%. At the scale of large Combined Cycle power plants, which are very mature technologies where small improvements are hard to find, such a 1.8-point improvement (or 3% increase in thermal efficiency) would be a major advance in power production and emission reduction.

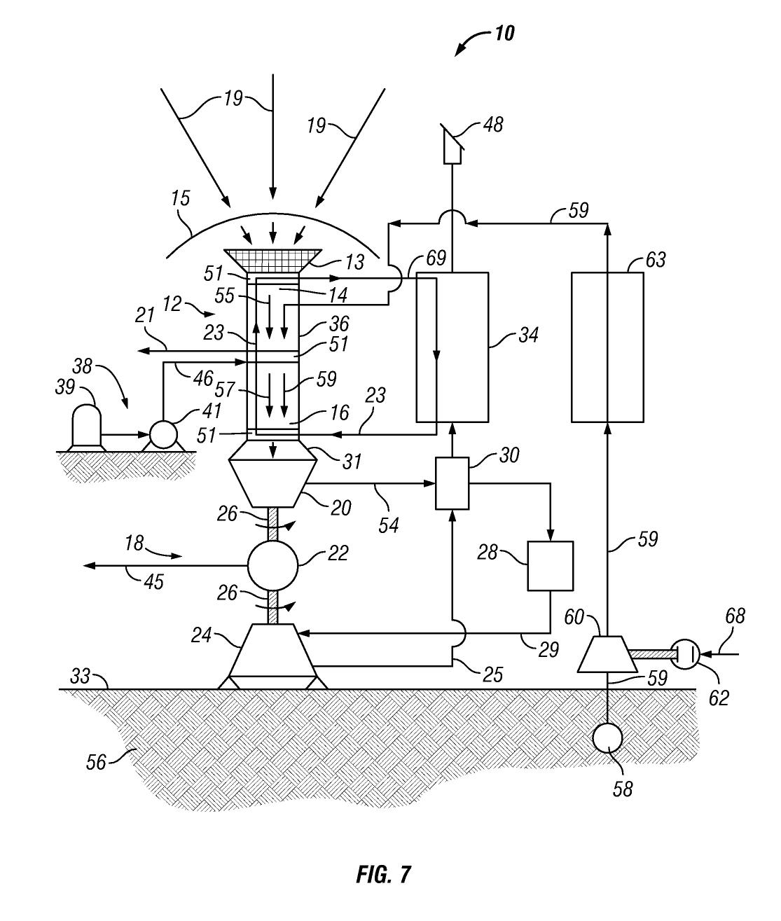

FIG. 7 illustrates yet another embodiment of the present invention, namely the deployment of the VCCP Cycle at a non-pipeline gaseous fuel facility. Gaseous fuel gathering systems routinely use the recovered fuel in engines and gas turbines to produce power for sale on the electric grid. Standard systems that use gas turbines as the prime mover have the same drawbacks discussed above, related to overall efficiency and related to achieving the power rating of the gas turbine during hot weather. The present invention mitigates those drawback in ways similar to the other embodiments, namely by achieving the full power rating of the turbine, even during hot summer days, and by achieving significantly higher efficiency, as measured by the amount of fuel required to produce a kilowatt-hour of electricity.

In FIG. 7, an embodiment of the power system as described above is shown in which the source of the fuel is not a natural gas pipeline operated by a local utility, but a gaseous fuel gathering system 58 buried within landfill 56, which delivers very-low-pressure, warm, moist “landfill gas,” i.e., non-pipeline gaseous fuel 59 that typically contains CO2 in large quantities and other non-methane components in smaller quantities. The fuel could be Anaerobic Digester Gas (ADG), coal-bed methane (CBM), gas from stranded wells, Associated Gas found with oil wells, or other gaseous fuels known in the art. A Distributive Generation application of the VCCP Cycle at a coal mine would use the CBM as a fuel, and would use the power output for various fans, conveyor motors and the like. Similarly, a DG application at, for example, a dairy farm would use the ADG as fuel and the power output to run pumps, lights, and refrigeration equipment.

Blower 60 is shown immediately near the gathering system's vertical extension out of the landfill and is in fluid connection with the gaseous fuel gathering system 58. Blower 60 is powered by motor 62 which gets its power, first from a battery, (not shown) and then, once the system is running, from the power output 45 leaving generator 22. Specifically, a portion of the power output 45 is re-directed to motor 62 and is shown as power stream 68. The blower is configured to “pull” or draw the low-pressure non-pipeline gaseous fuel 59 from the gathering system and to bring it to above atmospheric pressure, say, to 15 psia, so that it can continue on its way to compressor 20. Thus, non-pipeline gaseous fuel 59 flows from gaseous fuel gathering system 58 to methanol cleaning system 63, which is in fluid connection with the blower 60 and the cold flue assembly 12.

Non-pipeline gaseous fuel 59 is sent through methanol cleaning system 63 that removes those volatile organic compounds that would be harmful to the hardware and which should not end up in combustion chamber 28, for reasons related to emission control. The designs of such cleaning systems are well understood by those in the non-pipeline gas processing industry, and would likely include small containers of methanol through which the gaseous fuel would be “bubbled” through, allowing the methanol to retain those components of the gaseous fuel that should not move on in the cycle. Periodic replacement of the methanol would occur, with the “dirty” methanol removed to an appropriate, licensed disposal facility. The configuration of methanol cleaning system 63 is shown in FIG. 7 simply as a “box” within the process because it is well understood by those familiar with the art of gaseous fuel clean up, and because there are several alternative designs for such a system, depending on gaseous fuel flow rate and the composition of the gaseous fuel.

It should be noted that the reduction in emissions provided by the VCCP system is even greater in embodiments that use non-pipeline gaseous fuels such as ADG and CBM, which are not as clean as pipeline natural gas, LNG or LPG, because of methanol cleaning system 63. Thus, the VCCP cycle reduces emissions with those fuels by increasing the efficiency of the power plant, and because it includes a methanol fuel treatment system for the sake of keeping the turbine components from being damaged by the non-methane, organic components in the fuel stream. For example, methanol-cleaning system 63 will remove siloxanes, which if left in the fuel stream can damage the turbine components because siloxane is abrasive. Methanol absorbs the “nastiest” components of non-pipeline gaseous fuel 59 in a fortuitous manner: It has an affinity to various volatile organic compounds (VOC), which are toxic but occur in low volumes. A small quantity of methanol will first absorb siloxane and VOCs. A larger quantity will then absorb CO2, and a large quantity would then absorb water. Thus, by limiting the quantity of the methanol in the drums through which the LFG is “bubbled”, the system can “select” what it wants to capture. The simplest and most cost-effective design would aim for the low-volume but most toxic components. In any event, the water removal is best accomplished in the cold flue 12, by refrigeration, with recovered cold from the condensed water. If the methanol were used for that purpose it would require a much larger methanol disposal system, more make-up methanol, and/or a complex system for separating the water from the methanol. Any “carry-over” of small quantities of methanol would be eliminated by passing the relatively clean gaseous fuel through an activated charcoal filter, which would absorb the trace amounts of methanol in the stream. That step would protect the aluminum heat exchangers from the corrosive effects of methanol.

The partially cleaned non-pipeline gaseous fuel 59 would exit methanol cleaning system 63 with much of its water and CO2 content undiminished, and at slightly lower pressure. Partially cleaned non-pipeline gaseous fuel 59 then is directed to the top 14 of cold flue assembly 12 and enters the cold flue assembly. As in other embodiments discussed in detail above, cold flue assembly 12 has a top 14 and bottom 16 and comprises plate fin heat exchanger 36. The cold flue assembly 12 operates in a vertical configuration such that air 19 and non-pipeline gaseous fuel 59 enter the top and fall to the bottom. The gaseous fuel would travel as a separate stream downward within a series of “chambers” within the cold flue, much the same as the falling air. However, because the gaseous fuel contains CO2 and some N2, the total volume of air dropping down the cold flue 12 toward the compressor 20 would be somewhat less than, say, the air flow shown in FIG. 1.

Absorption chiller 34 directs a pumped to pressure refrigerant 23 into cold flue assembly 12. The refrigerant rises within the cold flue assembly and through heat exchange cools the air and gaseous fuel as they fall within the cold flue assembly. Some embodiments of the system may include an antifreeze delivery system 38 to prevent icing within the heat exchanger. The antifreeze delivery system may include antifreeze tank 39 and antifreeze pump 41 to facilitate delivery of the antifreeze to the cold flue assembly.

The water content of the gaseous fuel would be “knocked out” at an intermediate point along its route down the cold flue by condensation, as is the case for the water content of the falling air. Condensation plates 44 (as shown in FIG. 2A) are disposed in cold flue assembly 12 at an intermediate point in the interior of the assembly. Condensed water from both the falling air and the falling gaseous fuel can be collected in condensation plates 44, such that the condensed water flows out of the flue before it freezes, and allows the mostly dry air to continue falling. The total outflow of condensed, cool water would be greater than in FIG. 1 because the gaseous fuel contains more moisture. Stream 21 shows the cold condensed water outflow, which would be returned to the top of the cold flue for pre-cooling of the inlet air and inlet gaseous fuel stream entering the cold flue assembly 12, like in the other embodiments. Once that water stream has absorbed heat from the falling air and gaseous fuel, it would be sent to the absorption chiller's cooling tower as make-up water, or back to the landfill for disposal.

As discussed in more detail above, a turbine assembly 18 comprises air compressor 20, generator 22 and hot gas expansion turbine 24, and the air compressor is located directly below cold flue assembly 12 and is connected thereto. Also as in other embodiments, turbine assembly 18 may be on shaft 26 and may operate in a vertical configuration such that the plane of rotation of air compressor 20, generator 22 and hot gas expansion turbine 24 is parallel to the ground. Alternatively, the turbine assembly may be configured in the traditional, horizontal arrangement. Thus, the falling gaseous fuel would join the falling cold air at the bottom 16 of the cold flue assembly 12 and would, as a single stream, enter the compressor 20, and be compressed to 60 psia. The combined cold compressed air/gaseous fuel stream 54 would continue in the cycle, on to the recuporator 30 for warming by heat exchange with hot exhaust stream 25 from hot gas expansion turbine 24, then to the combustion chamber 28, where the air and gaseous fuel mixture would be combusted, producing a very hot gas (say, 1,600° F.), that would exit the combustion chamber at 60 psia and would be expanded to 15 psia in the expander 24. At least some waste heat from the hot gas expansion turbine's exhaust stream 25 that warmed the stream of gaseous fuel and compressed air in recuperator 30 is directed from recuperator 30 to absorption chiller 34 for heat recovery, the waste heat providing energy to absorption chiller 34 to produce refrigeration. Finally, the remaining waste heat is sent to hot flue 48 for final exit to the atmosphere, much like in FIG. 1.

The embodiment illustrated in FIG. 7 may also be installed as a retrofit system if an existing non-pipeline gaseous fuel site has a “standard” turbine configured as a power plant. The elements of such a retrofit system would include cold flue assembly 12 with ethanol antifreeze system 38 and absorption chiller 34 to provide refrigeration. Blower 60 shown at the bottom right, may already be at the existing facility so that the existing turbine's compression work load is reduced by the amount of compression achieved by the blower. If the blower is not there, it would be installed as part of the retrofit package. Similarly, the existing power plant might include dryers and pre-clean up systems. Those systems could be enhanced or replaced with methanol cleaning system 63. It is also conceivable that an existing gaseous fuel-to-kW site is now using an internal combustion engine as the prime mover. In that retrofit, the engine would be replaced with all of the components shown in FIG. 7, but may keep some of the ancillary equipment, such as the gathering system, a blower (if it exists) and any gaseous fuel clean up systems that are useful. In summary, the key components of the VCCP Cycle, as illustrated in FIG. 7, could be used in a retrofit application (including where the existing turbine is in a horizontal mode), with each retrofit requiring site-specific integration.

The power systems and retrofit systems and their components described may be useful in other applications, such as the absorption chiller, where its operation “by gravity” can significantly enhance refrigeration output where refrigeration systems operate at near- or moderate-vacuum, where the effect of gravity on a dense fluid would be more pronounced. There are several applications for plate-fin heat exchangers that may operate at vacuum conditions, such as in pharmaceutical production. It should be noted that a vertically configured cold flue assembly standing alone could be retrofitted to improve the efficiency of any system that includes heat exchange between at least two fluid streams.

Thus, it is seen that energy efficient power systems and retrofits are provided, including systems and methods for improving the performance of gas turbine power systems. It should be understood that any of the foregoing configurations and specialized components may be interchangeably used with any of the systems of the preceding embodiments. Although preferred illustrative embodiments of the present invention are described hereinabove, it will be evident to one skilled in the art that various changes and modifications may be made therein without departing from the invention. It is intended in the appended claims to cover all such changes and modifications that fall within the true spirit and scope of the invention.

The following list of reference numbers is provided to better explain and illustrate embodiments of the invention described and claimed herein and should not read as limiting the scope of any embodiments of the invention.
10—power system
11—not used
12—cold flue assembly
13—filter
14—cold flue assembly top
15—cold flue assembly cover
16—cold flue assembly bottom
17—insulating material
18—turbine assembly
19—air entering top of cold flue assembly
20—compressor
21—cold condensed water stream
22—generator
23—refrigerant
24—hot gas expansion turbine/expander
25—hot gas expansion turbine/expander exhaust stream
26—shaft
27—compressed air
28—combustion chamber
29—hot gas
30—recuperator
31—nozzle connector
32—water pump
33—ground level
34—absorption chiller
35—ambient air
36—plate fin heat exchanger
37—cold water pipes
38—antifreeze delivery system
39—antifreeze tank
40—not used
41—antifreeze pump
42—stream selection valve
43—heat exchanger
44—condensation plates
45—power output
46—antifreeze stream
47—shell
48—hot flue
49—pipeline natural gas supply
50—plates
51—manifolds
52—fins
53—chambers
54—combined cold compressed air/gaseous fuel stream
55—air in the top half of the cold flue assembly
56—landfill
57—air in the bottom half of the cold flue assembly
58—gaseous fuel gathering system
59—non-pipeline gaseous fuel
60—blower
61—warmed condensed water
62—motor
63—methanol cleaning system
64—outer shell
65—return air stream/recycled AC air
66—LNG supply
67—stream splitting valve
68—power stream re-directed to the drive motor
69—warm ammonia
70-99—not used
100—cold box
101—prime mover
102—first hot box
103—steam cycle
104—second hot box
105—cooling tower
106—external fins
107—not used
108—make up water to the cooling tower
109—water that evaporates from the cooling tower
110—LNG pump
111—vaporized LNG

What is claimed is:

1. A system improving the efficiency of heat exchange between at least two fluid streams comprising:
a vertical cold flue assembly comprising a plate fin heat exchanger and having a top and a bottom such that at least one fluid sinks through the top of the cold flue assembly, through the plate fin heat exchanger and through the bottom of the cold flue assembly.

2. The system of claim 1 wherein the at least one fluid includes air, the system configured to be integrated with an existing gas turbine power plant, further comprising:
an absorption chiller in fluid connection with the cold flue assembly and configured to receive at least some waste heat from the power plant's exhaust stream such that the waste heat can be used to provide energy to the absorption chiller;
the absorption chiller further configured to direct refrigerant into the cold flue assembly such that the refrigerant rises within the plate fin heat exchanger and cools the air as the air sinks through the plate fin heat exchanger.

3. The system of claim 2 integrated with a simple cycle gas turbine power plant comprising:
a turbine assembly comprising an air compressor, a generator and a hot gas expansion turbine, the air compressor located substantially directly below and in fluid connection with the cold flue assembly;
a recuperator in fluid connection with the hot gas expansion turbine, the air compressor and the absorption chiller; and
a combustion chamber in fluid connection with the recuperator and the hot gas expansion turbine;
wherein compressed air from the air compressor is directed to the recuperator, the recuperator warms the compressed air by heat exchange with a hot exhaust stream from the hot gas expansion turbine, and the warmed compressed air is directed to the combustion chamber;
wherein at least some waste heat from the hot gas expansion turbine's exhaust stream that warmed the compressed air in the recuperator is directed from the recuperator to the absorption chiller, the waste heat providing energy to the absorption chiller to produce refrigeration;
wherein the absorption chiller directs refrigerant into the cold flue assembly, the refrigerant rises within the plate fin heat exchanger and cools the air as the air sinks through the plate fin heat exchanger, and the cooled air sinks through the bottom of the cold flue assembly and into the air compressor.

4. A system improving the efficiency of a combined cycle power plant, comprising:
a vertical cold flue assembly comprising a plate fin heat exchanger and having a top and a bottom such that at least one fluid sinks through the top of the cold flue assembly, through the plate fin heat exchanger and through the bottom of the cold flue assembly;
an absorption chiller in fluid connection with the cold flue assembly and configured to receive at least some waste heat from the power plant's exhaust stream such that the waste heat can be used to provide energy to the absorption chiller;
the absorption chiller further configured to direct refrigerant into the cold flue assembly such that the refrigerant rises within the plate fin heat exchanger and cools the air as the air sinks through the plate fin heat exchanger.

5. The system of claim 4 wherein the at least one fluid includes air, the system integrated with a combined cycle power plant comprising:
a turbine assembly comprising an air compressor, a generator and a hot gas expansion turbine, the air compressor located substantially directly below and in fluid connection with the cold flue assembly;
a combustion chamber in fluid connection with the recuperator and the hot gas expansion turbine;
wherein at least some waste heat from the hot gas expansion turbine's exhaust stream is directed to the absorption chiller, the waste heat providing energy to the absorption chiller to produce refrigeration.

6. The system of claim 1 wherein the at least one fluid is air, the system further comprising condensation plates disposed within the plate fin heat exchanger for collecting condensed moisture from the sinking air;
wherein the condensed moisture collected is used to cool the air entering the cold flue assembly.

7. The system of claim 1 further comprising an antifreeze delivery system, wherein antifreeze is delivered into the cold flue assembly.

8. The system of claim 2 further comprising an antifreeze delivery system, wherein antifreeze is delivered into the cold flue assembly.

9. The system of claim 1 wherein the plate fin heat exchanger comprises plates configured to form concentric circles.

10. The system of claim 3 further comprising an air conditioning system connected to the cold flue assembly;
wherein the air is at least partially cooled prior to entering the cold flue assembly by a return air stream from the air conditioning system.

11. The system of claim 3 wherein the cold flue assembly is housed in a cold box, the air compressor, the generator and the hot gas expansion turbine are housed in a first hot box, and the combustion chamber and the recuperator are housed in a second hot box.

12. The system of claim 11 wherein the cold box, the first hot box and the second hot box are located underground.

13. The system of claim 11 further comprising an air conditioning system connected to the cold flue assembly;
wherein the air is at least partially cooled prior to entering the cold flue assembly by a return air stream from the air conditioning system.

14. The system of claim 11 wherein the air in the cold box is further cooled by one or more heat sinks.

15. The system of claim 2 configured to be integrated with a simple cycle power plant at a non-pipeline gaseous fuel facility, further comprising:
a blower configured to draw gaseous fuel from a gaseous fuel gathering system and in fluid connection with the gaseous fuel gathering system;
a motor to power the blower; and
a methanol cleaning system in fluid connection with the blower and the cold flue assembly.

16. The system of claim 3 integrated with a simple cycle power plant at a non-pipeline gaseous facility, further comprising:
a gathering system for a non-pipeline gaseous fuel;
a blower in fluid connection with the gathering system to draw the gaseous fuel from the gathering system;
a motor to power the blower; and
a methanol cleaning system in fluid connection with the blower and the cold flue assembly;
wherein the gaseous fuel flows from the gathering system to the methanol cleaning system, the gaseous fuel is cleaned by the methanol cleaning system, and the partially cleaned gaseous fuel is directed to the top of the cold flue assembly;
wherein the refrigerant rising within the cold flue assembly cools the gaseous fuel and the air as the gaseous fuel and air sink through the plate fin heat exchanger, the gaseous fuel sinks to the bottom of the cold flue assembly and joins the cooled air such that the gaseous fuel and the cooled air enter the air compressor as a single stream;
wherein the stream of gaseous fuel and compressed air from the air compressor is directed to the recuperator, the recuperator warms the stream of gaseous fuel and compressed air by heat exchange with a hot exhaust stream from the hot gas expansion turbine, and the warmed gaseous fuel and compressed air are directed as a single stream to the combustion chamber;
wherein at least some waste heat from the hot gas expansion turbine's exhaust stream that warmed the stream of gaseous fuel and compressed air in the recuperator is directed from the recuperator to the absorption chiller, the waste heat providing energy to the absorption chiller to produce refrigeration.

17. The power system of claim 5 wherein the air that enters the plate fin heat exchanger is further cooled by vaporizing at least one cryogenic fluid.

18. The system of claim 17 wherein the cryogenic fluid is used as a portion of a fuel stream to the combustion chamber.

19. The system of claim 17 wherein the vaporized cryogenic fluid is warmed by recovered heat from the exhaust gas, pre-warming the fluid before it enters the combustion chamber.

20. A simple cycle power system comprising:
a vertical cold flue assembly comprising a plate fin heat exchanger and having a top and a bottom such that at least one fluid including air sinks through the top of the cold flue assembly, through the plate fin heat exchanger and through the bottom of the cold flue assembly;
a turbine assembly comprising an air compressor, a generator and a hot gas expansion turbine, the air compressor located substantially directly below and in fluid connection with the cold flue assembly;
a substantially vertical shaft on which the air compressor, the generator and the hot gas expansion turbine are mounted such that the plane of rotation of the air compressor, the generator and the hot gas expansion turbine is substantially parallel to the ground;
an absorption chiller in fluid connection with the cold flue assembly;
a recuperator in fluid connection with the hot gas expansion turbine, the air compressor and the absorption chiller; and
a combustion chamber in fluid connection with the recuperator and the hot gas expansion turbine;
wherein compressed air from the air compressor is directed to the recuperator, the recuperator warms the compressed air by heat exchange with a hot exhaust stream from the hot gas expansion turbine, and the warmed compressed air is directed to the combustion chamber;
wherein at least some waste heat from the hot gas expansion turbine's exhaust stream that warmed the compressed air in the recuperator is directed from the recuperator to the absorption chiller, the waste heat providing energy to the absorption chiller to produce refrigeration; and
wherein the absorption chiller directs refrigerant into the cold flue assembly, the refrigerant rises within the plate fin heat exchanger and cools the air as the air sinks through the plate fin heat exchanger, and the cooled air sinks through the bottom of the cold flue assembly and into the air compressor.

21. A method of improving the efficiency of a simple cycle power assembly comprising:
directing at least one fluid including air into a cold flue assembly comprising a plate fin heat exchanger and having a top and a bottom such that the fluid sinks through the top of the cold flue assembly, through the plate fin heat exchanger, and through the bottom of the cold flue assembly;
producing refrigerant and directing the refrigerant into the plate fin heat exchanger such that the refrigerant rises within the plate fin heat exchanger and cools the air as the air sinks through the plate fin heat exchanger;
warming compressed air by heat exchange with a hot exhaust stream, directing the warmed compressed air to a combustion chamber, and using at least some waste heat from the hot exhaust stream that warmed the compressed air to provide energy to produce refrigeration.

22. The method of claim 21 further comprising the steps of: collecting condensed moisture from the sinking air on condensation plates disposed within the plate fin heat exchanger; and
using the condensed moisture to cool the air entering the cold flue assembly.

23. The method of claim 21 further comprising delivering antifreeze into the cold flue assembly.

24. The method of claim 21 further comprising configuring plates in concentric circles within the plate fin heat exchanger.

25. The method of claim 21 further comprising the steps of:
connecting an air conditioning system to the cold flue assembly;
directing a return air stream from the air conditioning system to the cold flue assembly such that the air is cooled prior to entering the cold flue assembly by the return air stream from the air conditioning system.
